(19) United States
(12) Patent Application Publication
(10) Pub. No.: US 2007/0178962 A1
(43) Pub. Date: Aug. 2, 2007

(54) Gaming machine

(75) Inventor: Kazunobu Sato, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP.

(21) Appl. No.: 11/655,273

(22) Filed: Jan. 19, 2007

(30) Foreign Application Priority Data
Jan. 20, 2006 (JP) P2006-011813

(51) Int. Cl. A63F 13/00

(52) U.S. Cl. 463/20

(57) ABSTRACT

A gaming machine includes: a display device that displays a plurality of selectable elements including at least one first selectable element, at least one of the selectable elements being associated with an extra information that relates to a game; an input device that accepts an input selecting at least one of the selectable elements; and a processor that controls the display device based on the input from the input device, wherein the processor is operable to: determine whether a selectable element selected through the input device is the first selectable element; designate at least one selectable element other than the selected selectable element if the selected selectable element is the first selectable element; and display reference information based on the extra information corresponding to the designated selectable element on the display device.

CROSS-REFERENCE TO RELATED APPLICATIONS

This application is based upon and claims the benefit of priority from Japanese Patent Application No. 2006-011813, filed on Jan. 20, 2006, the entire contents of which are incorporated herein by reference.

### BACKGROUND OF THE INVENTION

1. Field of the invention

The present invention relates to a gaming machine capable of performing a game that provides an award corresponding to a selectable element selected by a player.

2. Description of the Related Art

In a gaming machine to date such as a slot machine, a bonus game has been performed. In a kind of the bonus game, the player selects one of displayed selectable elements, and an award corresponding to the selectable element selected by the player is provided. However, since the award provided to the player has been only for the selectable element selected by the player, it has been difficult for the player to expect an award corresponding to selectable elements other than the player's selection.

U.S. Pat. No. 6,817,944 discloses a slot machine capable of performing a selection game similar to the bonus game described above. In the selection game, when the player selects a specified selectable element, a selectable element neighboring the specified selectable element is automatically selected, and an award corresponding to the automatically selected selectable element is added.

However, the automatically selected selectable element at a time of selecting the specified selectable element by the player is limited to the selectable element neighbouring the specified selectable element. That is, the award is added within a range predictable by the player. Therefore, the longer a playing is continued, the more the player may feel the playing to be monotonous.

### SUMMARY OF THE INVENTION

An object of the invention is to provide a gaming machine that can give a novel sensation to a player of a game in which an award corresponding to a selectable element selected by the player is provided.

According to an aspect of the invention, there is provided a gaming machine including a display device that displays a plurality of selectable elements including at least one first selectable element, at least one of the selectable elements being associated with an extra information that relates to a game; an input device that accepts an input selecting at least one of the selectable elements; and a processor that controls the display device based on the input from the input device, wherein the processor is operable to: determine whether a selectable element selected through the input device is the first selectable element; designate at least one selectable element other than the selected selectable element if the selected selectable element is the first selectable element; and display reference information based on the extra information corresponding to the designated selectable element on the display device.

### BRIEF DESCRIPTION OF THE DRAWINGS

FIG. 1 is a view showing an example in which an “anemonefish” which has jumped out of a lower treasure box selected by a player in a treasure bonus game opens peripheral lower treasure boxes and their contents are displayed;

FIG. 2 is a perspective view of a slot machine;

FIG. 3 is a view showing nine variable display portions;

FIG. 4 is a view showing eight pay lines;

FIG. 5 is a block diagram schematically showing a control system of the slot machine;

FIG. 6 is a block diagram schematically showing a control system of the slot machine;

FIG. 7 is a view showing a symbol array (video reel) variably displayed while scrolling in each of the variable display portions of a lower liquid crystal display at a time of a game;

FIG. 8 is an illustration showing a lottery table used when determining a visible stop symbol when playing the game using the nine variable display portions;

FIG. 9 is an illustration of a payout table showing winning combinations and their awards in the case of playing the game using the nine variable display portions;

FIG. 10 is a flowchart of a main process program;

FIG. 11 is a flowchart of a start reception process program;

FIG. 12 is a flowchart of a lottery process program;

FIG. 13 is a flowchart of a game process program;

FIG. 14 is a flowchart of another game process program;

FIG. 15 is a view showing an example in which scatter symbols are visibly stopped, one in each of three variable display portions on the lower liquid crystal display;

FIG. 16 is a view showing display details of the lower liquid crystal display when proceeding to a shell chance game;

FIG. 17 is a n illustration showing a table used when determining content of each shell in the shell chance game;

FIG. 18 is a view showing an example in which the content of each shell are displayed on the lower liquid crystal display in the shell chance game;

FIG. 19 is a flowchart of a treasure bonus process program;

FIG. 20 is a view showing display details of the lower liquid crystal display when proceeding to the treasure bonus game;

FIG. 21 is a view showing an example of a numbering of each lower treasure box in the treasure bonus game;

FIG. 22 is a n illustration showing a table used when determining content (one of “5”, “10”, “20”, “30”, “40”, “50”, “60”, “70”, “80”, “100” or “200”) of each lower treasure box in the treasure bonus game;

FIG. 23 is a n illustration showing a table used when determining an existence or otherwise of the “anemonefish” for each lower treasure box in the treasure bonus game;

FIG. 24 is a view showing an example in which three lower treasure boxes selected by the player in the treasure bonus game are opened and their contents displayed;

FIG. 25 is a view showing an example in which the anemonefish which has jumped out of the lower treasure box selected by the player in the treasure bonus game is displayed;

FIG. 26 is a view showing display details of an upper liquid crystal display when proceeding to the treasure bonus game;

FIG. 27 is a view showing an example of a numbering of each upper treasure box in the treasure bonus game;

FIG. 28 is a n illustration showing a table used when determining content (one of “number of times+once”, “number of times+twice” or “number of times+three times”) of a first upper treasure box in the treasure bonus game;

FIG. 29 is a n illustration showing a table used when determining content (one of “award×2”, “award×3”, “award×5”, or “award×10”) of a second upper treasure box in the treasure bonus game;

FIG. 30 is a n illustration showing a table used when determining content (one of “100”, “200”, “number of times+three times”, “award×5”, “award×10” or “all awards×2”) of a third upper treasure box in the treasure bonus game;

FIG. 31 is a n illustration showing a table used when determining which upper treasure box the “anemonefish” opens in the treasure bonus game;

FIG. 32 is a view showing an example in which content of the upper treasure box the “anemonefish” has opened in the treasure bonus game is displayed;

FIG. 33 is a flowchart of an object process program;

FIG. 34 is a n illustration showing a table used when determining whether or not there is a peripheral information disclosure in the object process program;

FIG. 35 is a n illustration showing a table used when determining a subject of the peripheral information disclosure in the object process program;

FIG. 36 is a view showing an example in which content is displayed whereby the anemonefish which has jumped out of the lower treasure box selected by the player in the treasure bonus game indicates a subsequent selection of the treasure box; and

FIG. 37 is a n illustration of a table showing a correlation relationship between a flag and tables used when performing a peripheral information disclosure process in the object process program.

### DETAILED DESCRIPTION OF THE PREFERRED EMBODIMENTS

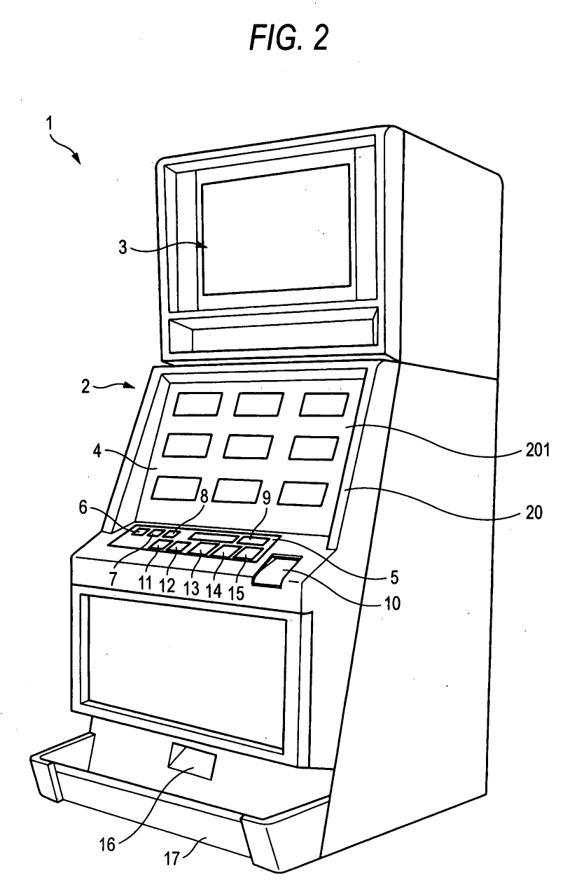

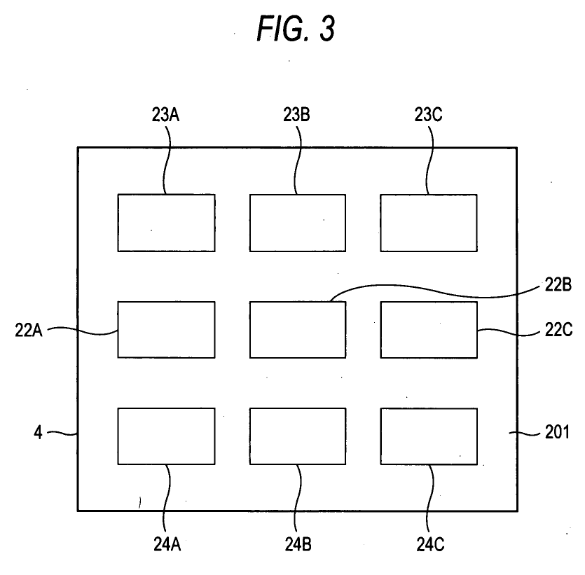

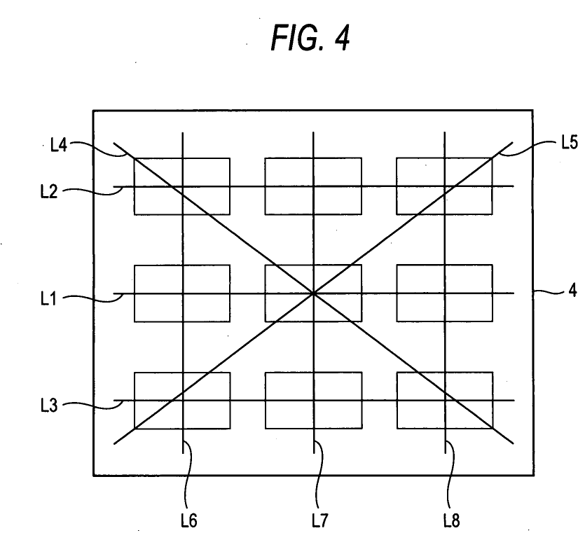

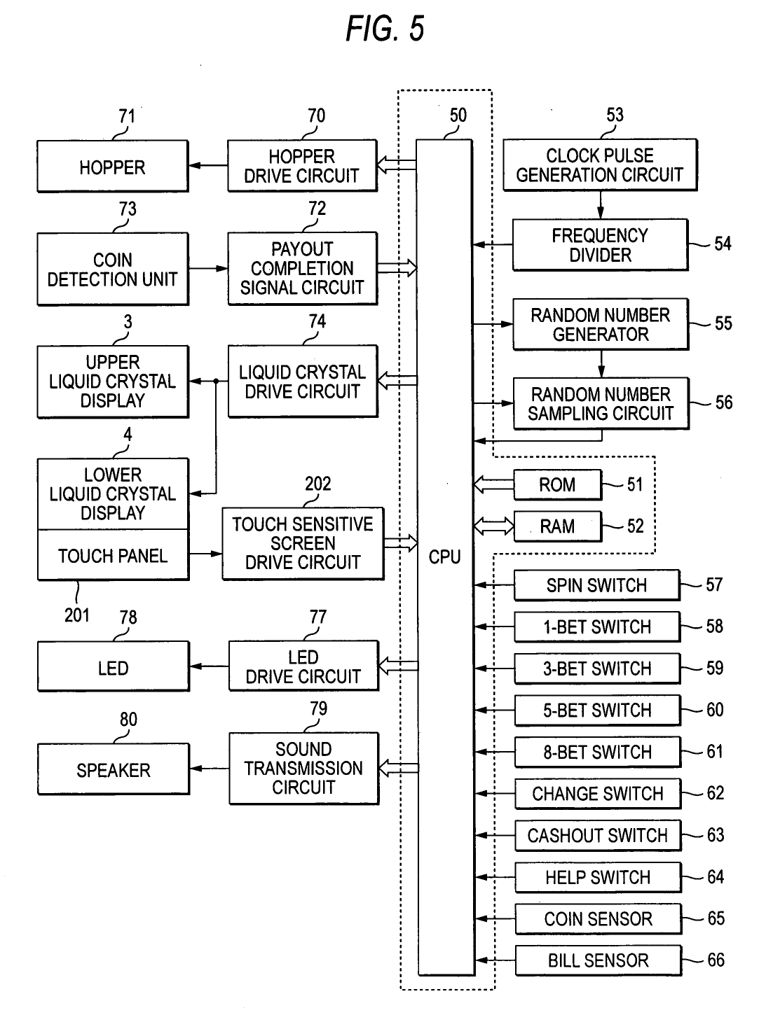

A gaming machine according to an embodiment of the invention will be hereinafter described in detail, while referring to the drawings. In the embodiment, a slot machine will be explained as an example of the gaming machine. Firstly, an outline configuration of the slot machine according to the embodiment will be described based on FIGS. 2 to 5. FIG. 2 is a perspective view of the slot machine. FIG. 3 shows nine variable display portions. FIG. 4 shows eight pay lines. FIG. 5 is a block diagram schematically showing a control system of the slot machine.

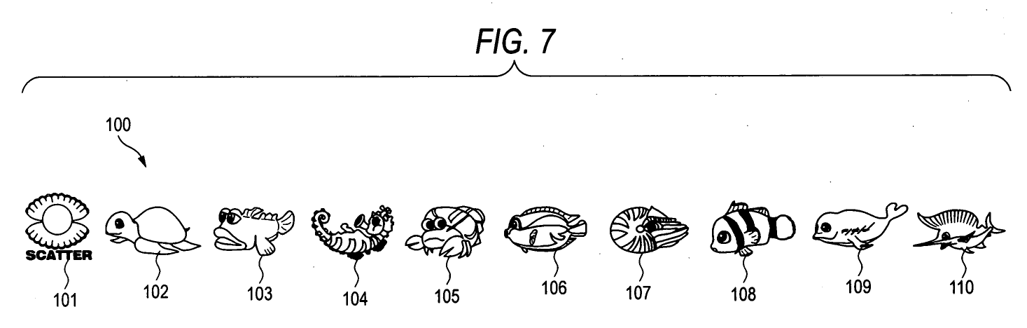

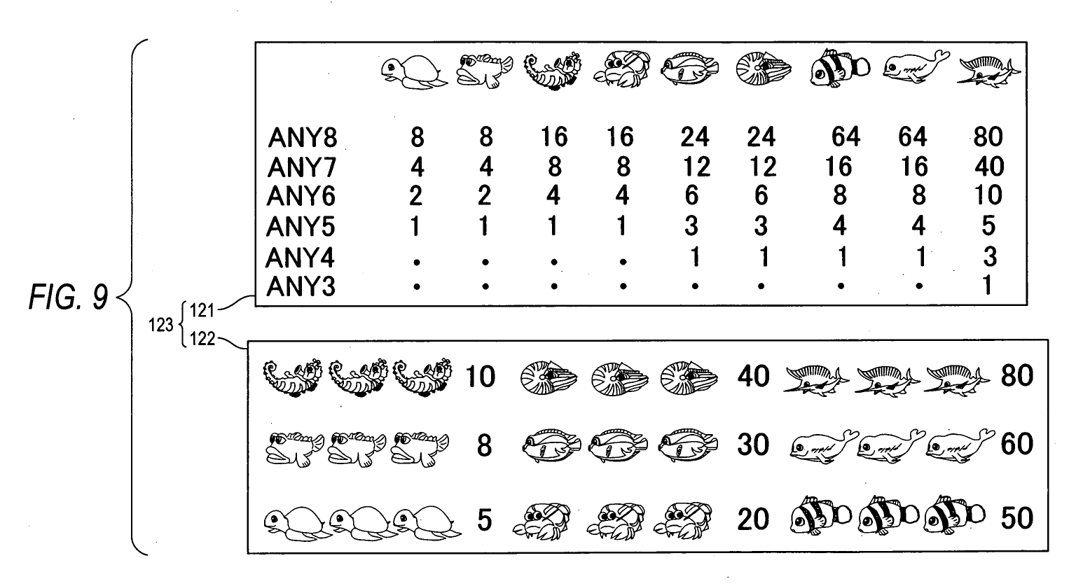

As shown in FIG. 2, a slot machine 1 includes a cabinet 2 as a framework of the entire slot machine 1. An upper liquid crystal display 3 is disposed in an upper front portion of the cabinet 2, and a lower liquid crystal display 4 is disposed in a front-middle portion of the cabinet 2 to be placed inside an apparatus front panel 20. The upper liquid crystal display 3 and the lower liquid crystal display 4 are a general-purpose liquid crystal displays, and a transparent touch sensitive screen 201 is disposed on the front surface of the lower liquid crystal display 4. On the upper liquid crystal display 3, a gaming method, an award display 123 showing a type of a winning combination and an award thereof (see FIG. 9, described later), and information related to a game such as various kinds of effect related to the game are displayed. On the lower liquid crystal display 4, nine variable display portions 22A to 22C, 23A to 23C and 24A to 24C (see FIG. 3), and a maximum of eight activated pay lines L1 to L8 (see FIG. 4) are displayed. Also, in each of the variable display portions 22A to 22C, 23A to 23C and 24A to 24C, each symbol configuring a video reel 100 (see FIG. 7, described later) is variably displayed while scrolling from a right direction towards a left direction.

An operation table 5 is provided at a bottom of the lower liquid crystal display 4 to project to the front side. A CHANGE button 6, a CASHOUT button 7 and a HELP button 8 are arranged in this order rightward on the operation table 5. A coin insertion slot 9 and a bill insertion slot 10 are provided on a right of the HELP button 8. Furthermore, a 1-BET button 11, a spin (SPIN/REPEATBET) button 12, a 3-BET button 13, a 5-BET button 14 and an 8-BET button 15 are arranged in this order rightward on a front of the operation table 5.

The CHANGE button 6 is a button which is depressed in changing a bill that is inserted through the bill insertion slot 10. A coin for which a bill is changed is paid out to a coin receiving tray 17 from a coin payout opening 16 provided in a lower portion of the cabinet 2. A CHANGE switch 62 (described later) is provided to be associated with the CHANGE button 6. When the CHANGE button 6 is depressed, a switch signal based on the depression is transmitted from the CHANGE switch 62 to a CPU 50 (see FIG. 5).

The CASHOUT button 7 is a button which is depressed when the game has finished. When the CASHOUT button 7 is depressed, coins acquired in the game are paid out to the coin receiving tray 17 from the coin payout opening 16. A CASHOUT switch 63 (described later) is provided to be associated with the cash out button 7. When the cash out button 7 is depressed, a switch signal based on the depression is transmitted from the CASHOUT switch 63 to the CPU 50 (see FIG. 5).

The HELP button 8 is a button which is depressed when a game operating method, for example, is unclear. When the HELP button 8 is depressed, various kinds of help information are displayed on the upper liquid crystal display 3. A HELP switch 64 (described later) is provided to be associated with the HELP button 8. When the HELP button 8 is depressed, a switch signal based on the depression is transmitted from the HELP switch 64 to the CPU 50 (see FIG. 5).

A coin sensor 65 (described later) is provided in the coin insertion slot 9. When a coin is inserted into the coin insertion slot 9, a coin detection signal is transmitted from the coin sensor 65 to the CPU 50 (see FIG. 5).

A bill sensor 66 (described later) is provide in the bill insertion slot 10. When a bill is inserted into the bill insertion slot 10, a bill detection signal is transmitted to the CPU 50 from the bill sensor 66 (see FIG. 5).

The 1-BET button 11 is a button which effects one bet each time it is depressed. A 1-BET switch 58 (described later) is provided to be associated with the 1-BET button 11. When the 1-BET button 11 is depressed, a switch signal based on the depression is transmitted from the 1-BET switch 58 to the CPU 50 (see FIG. 5).

The SPIN/REPEATBET button 12 is a button for starting variable display of the symbols on the variable display portions 22A to 22C, 23A to 23C and 24A to 24C of the lower liquid crystal display 4 with a current number of bets or a previous number of bets when depressed. A spin switch 57 (described later) is provided to be associated with the SPIN/REPEATBET button 12. When the SPIN/REPEATBET button 12 is depressed, a switch signal based on the depression is transmitted from the spin switch 57 to the CPU 50 (see FIG. 5). One, two, three, five and eight bets can exist as a number of bets which can be bet by the depression of the SPIN/REPEATBET button 12.

The 3-BET button 13 is a button which effects three bets when depressed. A 3-BET switch 59 (described later) is provided to be associated with the 3-BET button 13, a switch signal based on the depression thereof is transmitted from the 3-BET switch 59 to the CPU 50 (see FIG. 5).

The 5-BET button 14 is a button which effects five bets when depressed. A 5-BET switch 60 (described later) is provided to be associated with the 5-BET button 14, a switch signal based on the depression thereof is transmitted from the 5-BET switch 60 to the CPU 50 (see FIG. 5).

The 8-BET button 15 is a button which effects eight bets when depressed. An 8-BET switch 61 (described later) is provided to be associated with the 8-BET button 15, a switch signal based on the depression thereof is transmitted from the 8-BET switch 61 to the CPU 50 (see FIG. 5).

Although one, two, three, five and eight bets can exist as a number of bets which can be bet by an operation of the 1-BET button 11, the SPIN/REPEAT button 12, the 3-BET button 13, the 5-BET button 14 and the 8-BET button 15. In this connection, when the number of bets is one, a predetermined one of the pay lines L1 to L8 becomes activated. When the number of bets is two, a predetermined two of the pay lines L1 to L8 become activated. When the number of bets is three, a predetermined three of the pay lines L1 to L8 become activated. When the number of bets is five, a predetermined five of the pay lines L1 to L8 become activated. When the number of bets is eight, all eight of the pay lines L1 to L8 become activated.

Naturally, it is also possible to accommodate a machine type provided with a separate button which enables all eight of the pay lines L1 to L8 to become activated with one bet.

Hereafter, to facilitate a description, it will be assumed that the game proceeds in a condition in which all eight of the pay lines L1 to L8 are activated, unless particularly noted otherwise.

At the bottom of the cabinet 2, the coin payout opening 16 and the coin receiving tray 17 for receiving coins paid through the coin payout opening 16 are provided. A coin detection unit 73 (described later) containing a sensor etc. is disposed inside the coin payout opening 16, and detects a number of coins paid out from the coin payout opening 16 (see FIG. 5).

Next, the symbols used in the game of the slot machine 1 will be described. FIG. 7 shows an array of symbols (video reel) which is variably displayed while scrolling in each of the variable display portions 22A to 22C, 23A to 23C and 24A to 24C of the lower liquid crystal display 4 at a time of the game.

The symbol array includes ten symbols that are a scatter 101, a sea turtle 102, a mudskipper 103, a sea horse 104, a hermit crab 105, a surgeonfish 106, an ammonite 107, an anemonefish 108, a seal 109 and a marlin 110, which constitute the video reel 100.

Next, a configuration related to a control system of the slot machine 1 will be described with reference to FIG. 5. FIG. 5 is a block diagram schematically showing the control system of the slot machine.

As shown in FIG. 5, the control system of the slot machine 1 is basically configured to have the CPU 50 as a core. A ROM 51 and a RAM 52 are connected to the CPU 50. The ROM 51 stores a main process program, a start reception process program, a lottery process program, a game process program, a lottery table for determining a visible stop symbol of the game by a lottery, and various other programs, data tables and the like necessary for a control of the slot machine 1, which are to be described later. The RAM 52 is a memory which temporarily stores various kinds of data as results of computation by the CPU 50.

A clock pulse generation circuit 53 for generating reference clock pulses and a frequency divider 54 are connected to the CPU 50. A random number generator 55 for generating a random number and a random number sampling circuit 56 are also connected to the CPU 50. A Random number sampled through the random number sampling circuit 56 is used in various lotteries for determining a winning combinations and the like. The SPIN switch 57 appended to the SPIN/REPEAT button 12, the 1-BET switch 58 appended to the 1-BET button 11, the 3-BET switch 59 appended to the 3-BET button 13, the 5-BET switch 60 appended to the 5-BET button 14, the 8-BET switch 61 appended to the 8-BET button 15, the CHANGE switch 62 appended to the CHANGE button 6, the CASHOUT switch 63 appended to the CASHOUT button 7, and the HELP switch 64 appended to the HELP button 8 are connected to the CPU 50. The CPU 50 performs a control to perform each kind of operation corresponding to the respective button based on the switch signal transmitted from the switch corresponding to the depressed button.

The coin sensor 65 provided in the coin insertion slot 9 and the bill sensor 66 provided in the bill insertion slot 10 are connected to the CPU 50. The coin sensor 65 detects the coin inserted through the coin insertion slot 9, and the CPU 50 calculates the number of inserted coins based on the coin detection signal transmitted from the coin sensor 65. The bill sensor 66 detects a kind/amount of a bill inserted through the bill insertion slot 10, and the CPU 50 calculates a number of coins equivalent to the value of the bill based on a bill detection signal transmitted from the bill sensor 66.

A hopper 71 is connected to the CPU 50 via a hopper drive circuit 70. When a drive signal is transmitted from the CPU 50 to the hopper drive circuit 70, the hopper 71 pays out a predetermined number of coins from the coin payout opening 16.

The coin detection unit 73 is connected to the CPU 50 via a payout completion signal circuit 72. The coin detection unit 73 is provided inside the coin payout opening 16. When it is detected that the predetermined number of coins has been paid out from the coin payout opening 16, a coin payout detection signal is transmitted from the coin detection unit 73 to the payout completion signal circuit 72. Based on the coin payout detection signal, the payout completion signal circuit 72 transmits a payout completion signal to the CPU 50. The upper liquid crystal display 3 and the lower liquid crystal display 4 are connected to the CPU 50 via a liquid crystal drive circuit 74, and the CPU 50 controls the upper liquid crystal display 3 and the lower liquid crystal display 4.

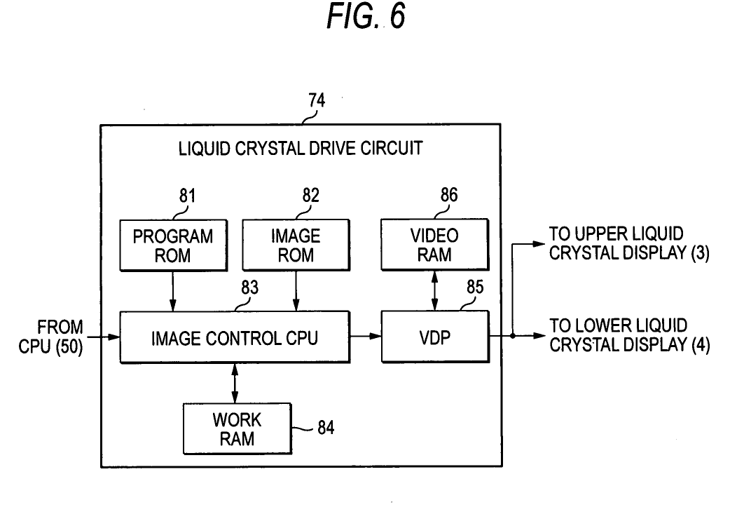

In this respect, as shown in FIG. 6, the liquid crystal drive circuit 74 includes a program ROM 81, an image ROM 82, an image control CPU 83, a work RAM 84, a VDP (Video Display Processor). 85, a video RAM 86 and the like. The program ROM 81 stores an image control program related to a display on the upper liquid crystal display 3 and the lower liquid crystal display 4, and various lottery tables. Also, the image ROM 82 stores dot data etc. for use in forming an image such as various images for a demonstration effect and a treasure bonus game which are performed on the upper liquid crystal display 3 and the lower liquid crystal display 4, various types of help information and a payout table which are displayed on the upper liquid crystal display 3, and the various symbols of the video reel 100 in FIG. 7 which are displayed in the variable display portions 22A to 22C, 23A to 23C and 24A to 24C (see FIG. 3) of the lower liquid crystal display 4. The image control CPU 83, based on a parameter set by the CPU 50, in accordance with the image control program stored in advance in the program ROM 81, chooses images to be displayed on the upper liquid crystal display 3 and the lower liquid crystal display 4 from among the dot data stored in advance in the image ROM 82. The work RAM 84 is configured as temporary storage means acting when the image control program is executed by the image control CPU 83. The VDP 85 forms an image in accordance with the display details chosen by the image control CPU 83, and transmits it to the upper liquid crystal display 3 and the lower liquid crystal display 4. By this means, for example, the various symbols of the video reel 100 shown in FIG. 7 and the like are variably displayed and visibly stopped in each of the variable display portions 22A to 22C, 23A to 23C and 24A to 24C of the lower liquid crystal display 4 (refer to FIG. 3). The video RAM 86 is configured as temporary storage means acting when an image is formed by the VDP 85.

In the variable display portions 22A to 22C, 23A to 23C and 24A to 24C, when the individual symbols of the video reel 100 being variably displayed by means of a scrolling are visibly stopped, one symbol is visibly stopped in each of the variable display portions 22A to 22C, 23A to 23C and 24A to 24C. Also, since the slot machine 1 is the similar to the general slot machine in that various kinds of winning combination is set in advance based on a plurality of kinds of symbol combination (see FIG. 9), when a symbol combination corresponding to a winning combination is stopped on each of the activated pay lines L1 to L8, coins are paid out from the coin payout opening 16 in accordance with the winning combination, a detailed description thereof will be omitted here.

Returning to FIG. 5, the transparent touch sensitive screen 201 is connected to the CPU 50 via a touch sensitive screen drive circuit 202. The transparent touch sensitive screen 201, as described above, is mounted on a screen of the lower liquid crystal display 4, it is possible to determine, via the touch sensitive screen drive circuit 202, based on coordinate position information of a portion touched by a player, where the player has touched. The touch sensitive screen 201 serves as an example of an input device that accepts an input selecting at least one of the selectable elements.

An LED 78 is connected to the CPU 50 via an LED drive circuit 77. A multiplicity of the LEDs 78 is disposed on a front of the slot machine 1. The LEDs 78 is controlled as to illumination by the LED drive circuit 77 based on a drive signal from the CPU 50 when performing various effects. A sound transmitting circuit 79 and a speaker 80 are connected to the CPU 50. The speaker 80 generates various sound effects when performing the various effects based on an output signal from the sound transmitting circuit 79.

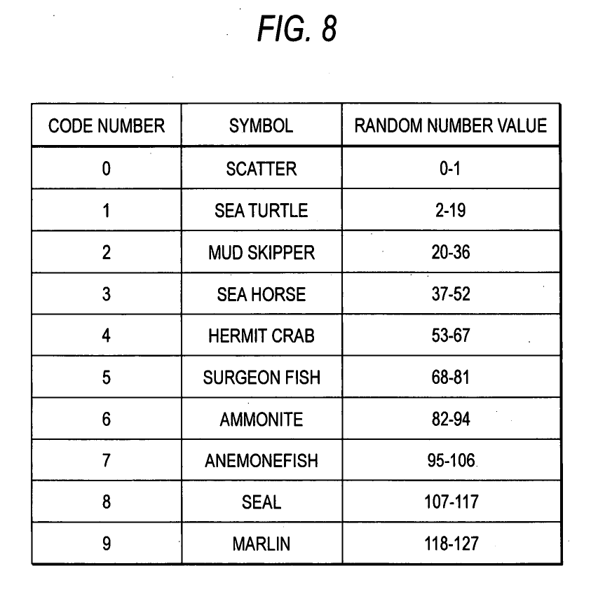

A lottery table will be described with reference to FIG. 8. The lottery table is used when determining by a lottery a symbol to be visibly stopped in each of the variable display portions 22A to 22C, 23A to 23C and 24A to 24C when playing the game on the slot machine 1 using the nine variable display portions 22A to 22C, 23A to 23C and 24A to 24C. FIG. 8 is an illustration showing the lottery table used when determining by a lottery the visible stop symbol when playing the game using the nine variable display portions. The lottery table shown in FIG. 8 is stored in the ROM 51.

Herein, a symbol to be visibly stopped in each of the variable display portions 22A to 22C, 23A to 23C and 24A to 24C is chosen for each of the variable display portions 22A to 22C, 23A to 23C and 24A to 24C. For this purpose, code numbers “0” to “9” are allotted to the symbols configuring the video reel 100 shown in FIG. 7, in order, from the left, while the lottery table shown in FIG. 8 is prepared in advance. Then, nine random number values are sampled via the random number sampling circuit 56 in such a way as to correspond to the individual variable display portions 22A to 22C, 23A to 23C and 24A to 24C.

Herein, to describe each symbol configuring the video reel 100 of the variable display portion 23A, as shown in the lottery table in FIG. 8, when the random number value sampled via the random number sampling circuit 56 falls in a range of 0 to 1, the scatter 101 symbol allotted to the code number “0” is visibly stopped in the variable display portion 23A. Similarly, the code numbers “1” to “9” are also allotted in the same way based on the lottery table in FIG. 8.

Symbols configuring the video reel 100 of each of the other variable display portions 22A to 22C, 23B, 23C and 224A to 24C are also similar to the symbols configuring the video reel 100 of the variable display portion 23A described heretofore.

Next, with reference to FIG. 9, winning combinations and their awards in the case of playing the game on the slot machine 1 using the nine variable display portions 22A to 22C, 23A to 23C and 24A to 24C will be described. FIG. 9 is an illustration of a payout table showing winning combinations and their awards in the case of playing the game using the nine variable display portions 22A to 22C, 23A to 23C and 24A to 24C.

The payout table 123 shown in FIG. 9 includes an any odds payout table 121 and a line odds payout table 122, and is stored by a table in the ROM 51.

The any odds payout table 121 shows, for each symbol, an award corresponding to the number of same symbols that are stop-displayed in the variable display portions (see FIG. 3) on activated pay lines (see FIG. 4) being displayed on the lower liquid crystal display 4. For example, when the code number of five of the nine variable display portions 22A to 22C, 23A to 23C and 24A to 24C on activated pay lines (see FIG. 4) is any of “2” to “19”, “ANY5 of sea turtle” is won (see FIG. 8). In this case, the sea turtle 102 being visibly stopped (see FIG. 7) in each of the five variable display portions on the activated pay lines (see FIG. 4), an award of “1” is obtained. Hereafter, each award of any odds is awarded in the same way based on the any odds payout table 121 shown in FIG. 9.

The line odds payout table 122 shows, for each symbol, an award corresponding to each activated pay line (displayed on the lower liquid crystal display 4) all the variable display portions on which have the same symbol being stop-displayed. For example, with regard to the nine variable display portions 22A to 22C, 23A to 23C and 24A to 24C, when all of the code numbers of all of the variable display portions on one activated pay line (see FIG. 4) from among the activated pay lines (see FIG. 4) are any of “2” to “19”, “sea turtle-sea turtle-sea turtle” is won (refer to FIG. 8) on the activated pay line (refer to FIG. 4). In this case, the sea turtles 102 is visibly stopped in all the variable display portions (refer to FIG. 7) on the activated pay line (refer to FIG. 4), an award of “5” is obtained. When there is a plurality of activated pay lines (refer to FIG. 4) on which “sea turtle-sea turtle-sea turtle” has been won, an award obtained by multiplying the number of activated pay lines and “5” together is obtained. Hereafter, each award of line odds is awarded in the same way based on the line odds payout table 122 shown in FIG. 9.

with regard to the nine variable display portions 22A to 22C, 23A to 23C and 24A to 24C, when the code numbers of three or more of the variable display portions on the activated pay lines (see FIG. 4) displayed in the lower liquid crystal display 4 are “0” or “1”, the scatter 101 symbol is visibly displayed (see FIG. 7) in each of the three or more variable display portions on the activated pay lines (see FIG. 4). Thereafter, a shell chance game is played out on the lower liquid crystal display 4.

FIG. 15 shows an example in which the scatter 101 is visibly displayed in each of three variable display portions on the lower liquid crystal display 4, in which example, it is possible to proceed to the shell chance game when at least three activated pay lines (refer to FIG. 4) are displayed on the lower liquid crystal display 4.

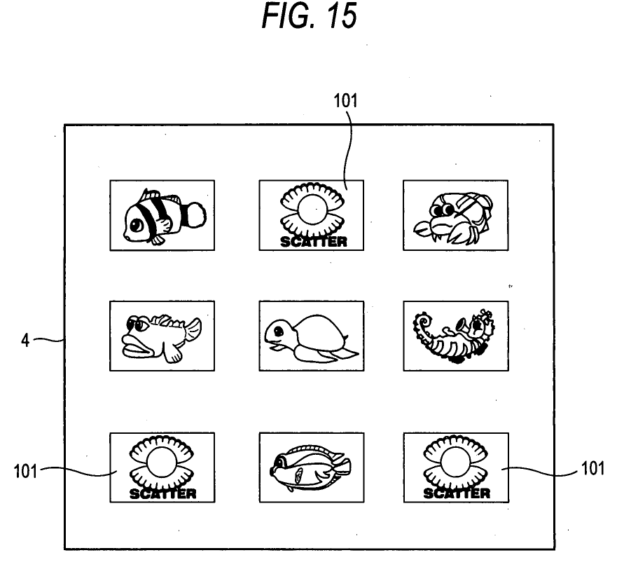

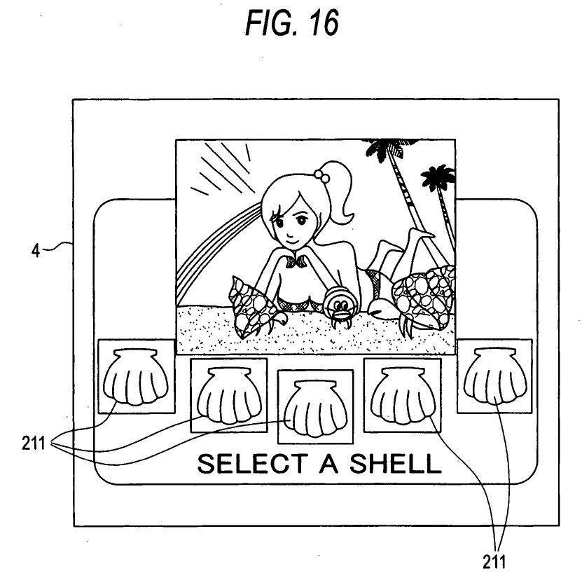

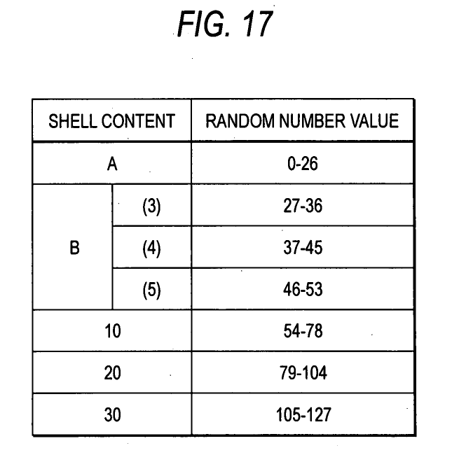

Then, when proceeding to the shell chance game, firstly, as shown in FIG. 16, five shells 211 are displayed on the lower liquid crystal display 4. Herein, one of “A”, “B(3)”, “B(4)”, “B(5)”, “10”, “20” or “30” is stored as each of contents of the five shells 211. In the embodiment, the contents of the shells 211 are determined by a lottery being performed for each of the shells 211 based on a table (see FIG. 17) and a random number value sampled in a range of 0 to 127 via the random number sampling circuit 56.

Consequently, according to the table in FIG. 17, when the random number value sampled via the random number sampling circuit 56 is any of “0” to “26”, “A” is selected as the content of the shell 211. Also, when the random number value sampled via the random number sampling circuit 56 is any of “27” to “36”, “B(3)” is selected as the content of the shell 211. Also, when the random number value sampled via the random number sampling circuit 56 is any of “37” to “45”, “B(4)” is selected as the content of the shell 211. Also, when the random number value sampled via the random number sampling circuit 56 is any of “46” to “53”, “B(5)” is selected as the content of the shell 211. Also, when the random number value sampled via the random number sampling circuit 56 is any of “54” to “78”, “10” is selected as the content of the shell 211. Also, when the random number value sampled via the random number sampling circuit 56 is any of “79” to “104”, “20” is selected as the content of the shell 211. Also, when the random number value sampled via the random number sampling circuit 56 is any of “105” to “127”, “30” is selected as the content of the shell 211.

Then, when the player selecting one of the five shells 211 displayed on the lower liquid crystal display 4 via a touch of the transparent touch sensitive screen 201, the contents of the five shells 211 (one of “A”, “B(3)”, “B(4)”, “B(5)”, “10”, “20” or “30”) are displayed on the lower liquid crystal display 4, as shown in FIG. 18. When “B(3)” is displayed, characters “B” and “3 times” are displayed. When “B(4)” is displayed, characters “B” and “4 times” are displayed. When “B(5)” is displayed, characters “B” and “5 times” are displayed. At this time, an arrow is also displayed on the lower liquid crystal display 4 in order to clarify which shell 211 the player has selected.

When the content of the shell 211 the player has selected is “A”, it is possible to proceed to another bonus game, but a detail of a description of the other bonus game will be omitted herein. Also, when the content of the shell 211 the player has selected is “B(3)”, “B(4)” or “B(5)”, it is possible to move to a treasure bonus game. Details of the treasure bonus game will be described later. Also, when the content of the shell 211 the player has selected is “10”, an award of “10” can be obtained. Also, when the content of the shell 211 the player has selected is “20”, an award of “20” can be obtained. Also, when the content of the shell 211 the player has selected is “30”, an award of “30” can be obtained.

In a condition in which the five shells 211 are displayed on the lower liquid crystal display 4, as shown in FIG. 16, in order to ensure a situation in which the player can feasibly select the other bonus game or treasure bonus game, it may be also acceptable to determine the contents of the five shells 211 displayed on the lower liquid crystal display 4 so that “A” and “B(3)”, “B(4)” or “B(5)” are always stored in one of them.

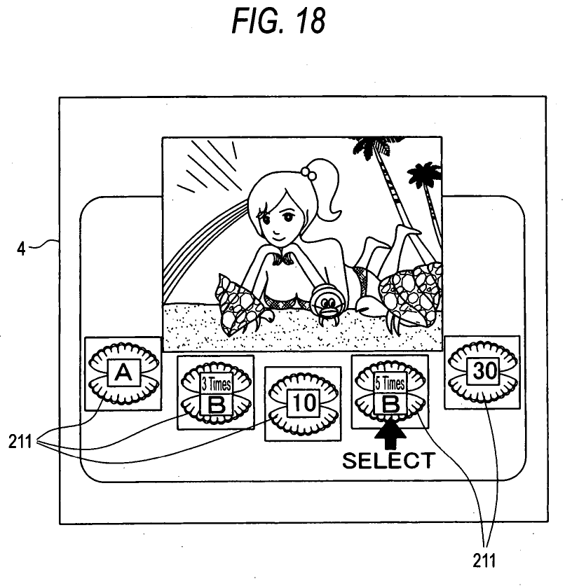

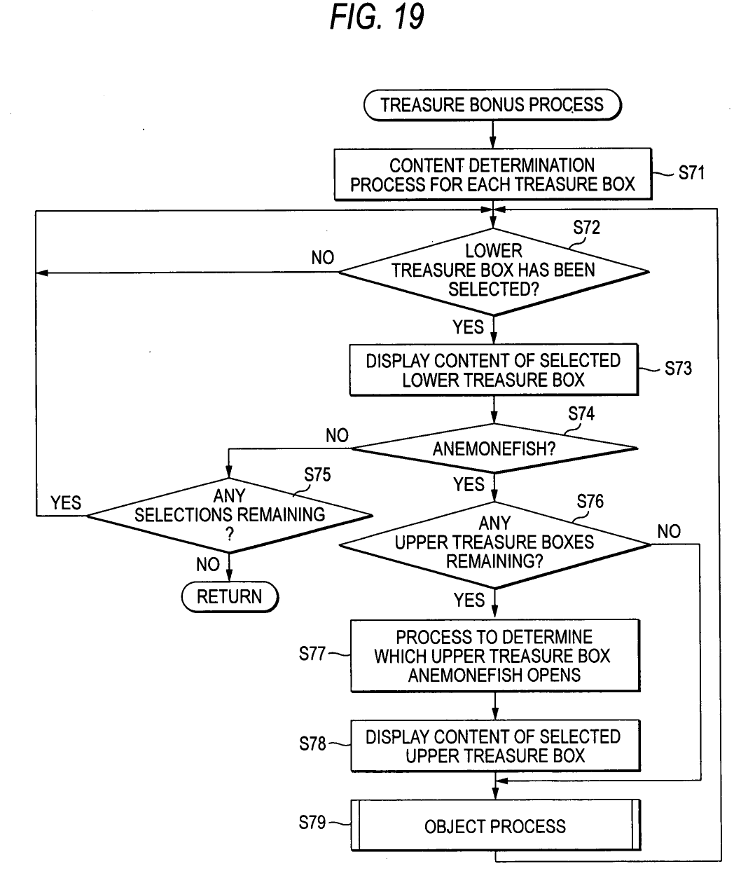

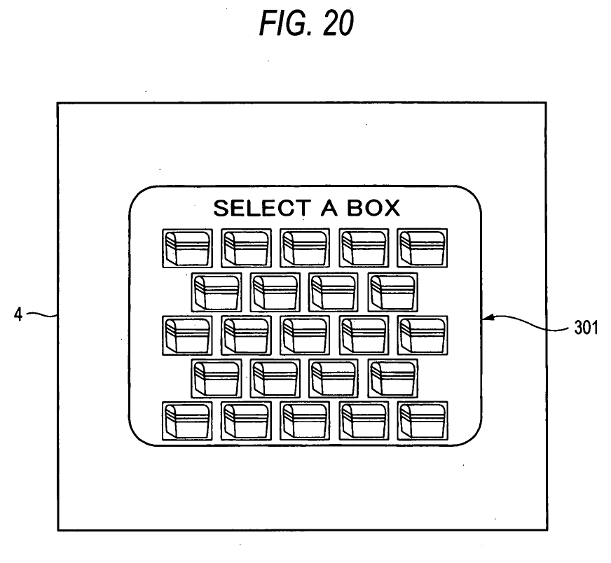

Next, a description will be given of the treasure bonus game. In the treasure bonus game, firstly, as shown in FIG. 20, 23 lower treasure boxes 301 are displayed on the lower liquid crystal display 4. Herein, one of “5”, “10”, “20”, “30”, “40”, “50”, “60”, “70”, “80”, “100” or “200” is stored as each of contents of the 23 lower treasure boxes 301. In the embodiment, the contents of the lower treasure boxes 301 are determined by a lottery being performed for each of the lower treasure boxes 301 based on a table (see FIG. 22) and a random number value sampled in a range of 0 to 127 via the random number sampling circuit 56.

Consequently, according to the table in FIG. 22, when the random number value sampled via the random number sampling circuit 56 is any of “0” to “7”, “5” is selected as the content of the lower treasure box 301. Hereafter, “10”, “20”, “30”, “40”, “50”, “60”, “70”, “80”, “100” and “200” are selected as the contents of the lower treasure box 301 in the same way.

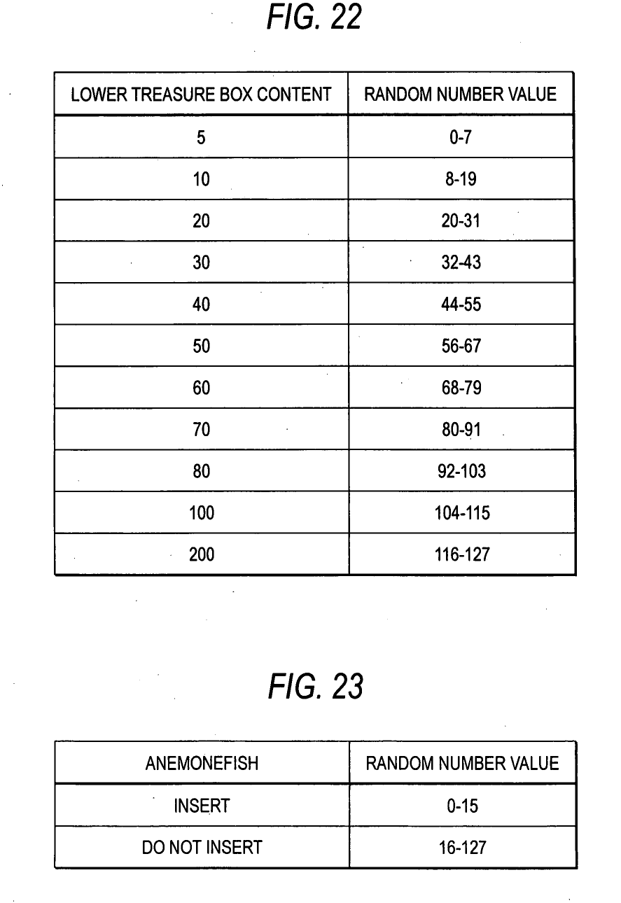

Furthermore, as well as the above described contents “5”, “10”, “20”, “30”, “40”, “50”, “60”, “70”, “80”, “100” and “200”, there exist the 23 lower treasure boxes 301 storing an anemonefish and not storing the anemonefish. In this embodiment, it is determined whether or not the anemonefish is stored by a lottery being performed for each of the lower treasure boxes 301 based on a table (refer to FIG. 23) and a random number value sampled in a range of 0 to 127 via the random number sampling circuit 56.

Consequently, according to the table in FIG. 23, when the random number value sampled via the random number sampling circuit 56 is any of “0” to “15”, the anemonefish is stored as the content of the lower treasure box 301. In contrast, when the random number value sampled via the random number sampling circuit 56 is any of “16” to “127”, the anemonefish is not stored as the content of the lower treasure box 301.

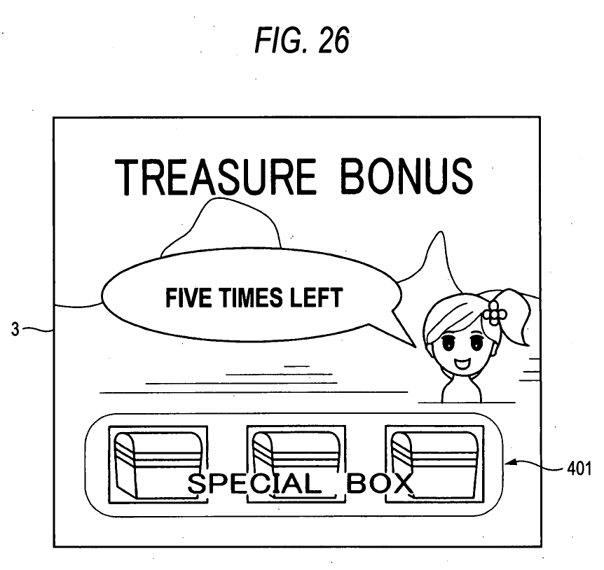

Meanwhile, as shown in FIG. 26, 3 upper treasure boxes 401 are displayed on the upper liquid crystal display 3. Herein, when specifying and describing any one of the 3 upper treasure boxes 401, it will be described, in order from a left to a right, as a first upper treasure box 401, a second upper treasure box 401, or a third upper treasure box 401.

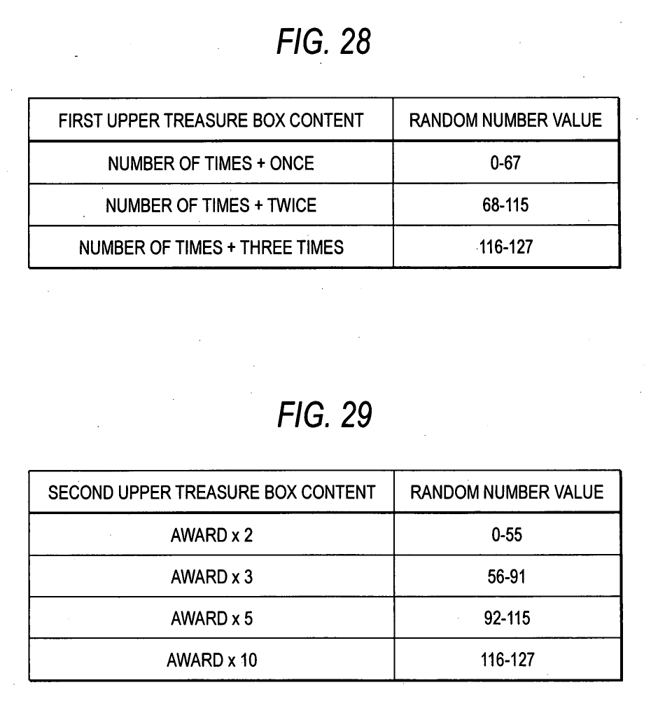

Then, one of “number of times+once”, “number of times+twice” or “number of times+three times” is stored as a content of the first upper treasure box 401. In this embodiment, the content of the first upper treasure box 401 is determined by a lottery being performed for the first upper treasure box 401 based on a table (see FIG. 28) and a random number value sampled in a range of 0 to 127 via the random number sampling circuit 56.

Consequently, according to the table in FIG. 28, when the random number value sampled via the random number sampling circuit 56 is any of “0” to “67”, “number of times+once” is selected as the content of the first upper treasure box 401. Hereafter, “number of times+twice” and “number of times+three times” are selected as the content of the first upper treasure box 401 in the same way.

Also, one of “award×2”, “award×3”, “award×5” or “award×10” is stored as a content of the second upper treasure box 401. In the embodiment, the content of the second upper treasure box 401 is determined by a lottery being performed for the second upper treasure box 401 based on a table (see FIG. 29) and a random number value sampled in a range of 0 to 127 via the random number sampling circuit 56.

Consequently, according to the table in FIG. 29, in the event that the random number value sampled via the random number sampling circuit 56 is any of “0” to “55”, “award×2” is selected as the content of the second upper treasure box 401. Hereafter, “award×3”, “award×5” and “award×10” are selected as the content of the second upper treasure box 401 in the same way.

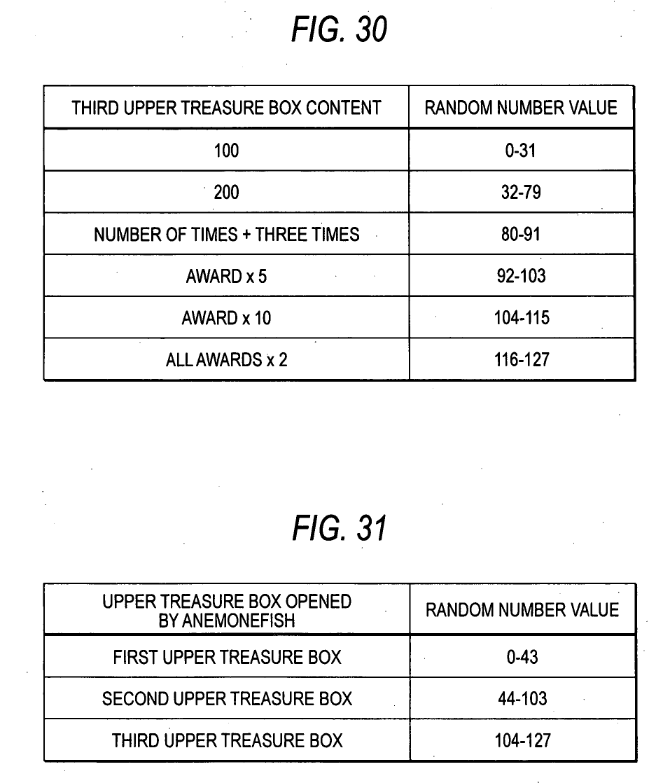

Also, one of “100”, “200”, “number of times+three times”, “award×5”, “award×10” or “all awards×2” is stored as a content of the third upper treasure box 401. In this embodiment, The content of the third upper treasure box 401 is determined by a lottery being performed for the third upper treasure box 401 based on a table (see FIG. 30) and a random number value sampled in a range of 0 to 127 via the random number sampling circuit 56.

Consequently, according to the table in FIG. 30, when the random number value sampled via the random number sampling circuit 56 is any of “0” to “31”, “100” is selected as the content of the third upper treasure box 401. Hereafter, “200”, “number of times+three times”, “award×5”, “award×10” and “all awards×2” are selected as the content of the third upper treasure box 401 in the same way.

Then, the player can select a predetermined number of the lower treasure boxes 301, from among the 23 lower treasure boxes displayed on the lower liquid crystal display 4, without betting a coin or the like, with a touch via the transparent touch sensitive screen 201. Herein, the predetermined number (the number of selection times) for selecting the lower treasure boxes 301 is three (times) when the content of the shell 211 having been selected by the player in the shell chance game is “B(3)”, four (times) when the content is “B(4)”, and five (times) when the content is “B(5)”. Also, when the player selects the predetermined number of the lower treasure boxes 301, every time the selection is made, the lower treasure box 301 which is the subject of the relevant selection is opened, and the content is displayed on the lower liquid crystal display 4. Furthermore, a remaining number of the predetermined number (the number of selection times) of the lower treasure boxes 301 is displayed on the upper liquid crystal display 3 (see FIG. 26). FIG. 24 shows an example in which three lower treasure boxes 301 selected by the player are opened and their contents displayed. However, in the example, the “anemonefish” is not stored in any of the three lower treasure boxes 301 selected by the player.

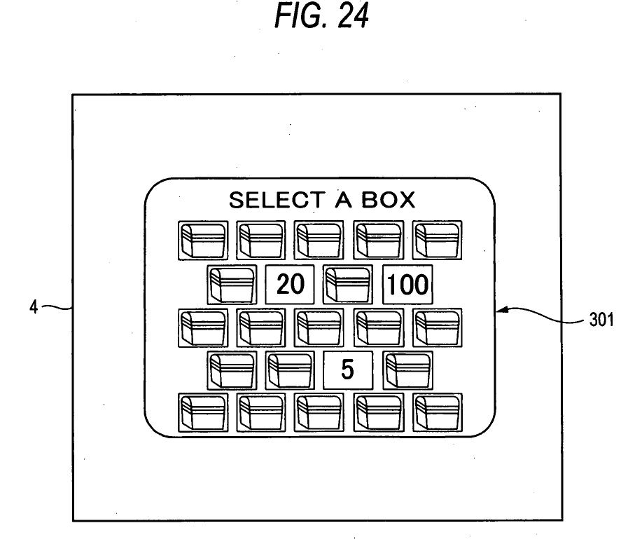

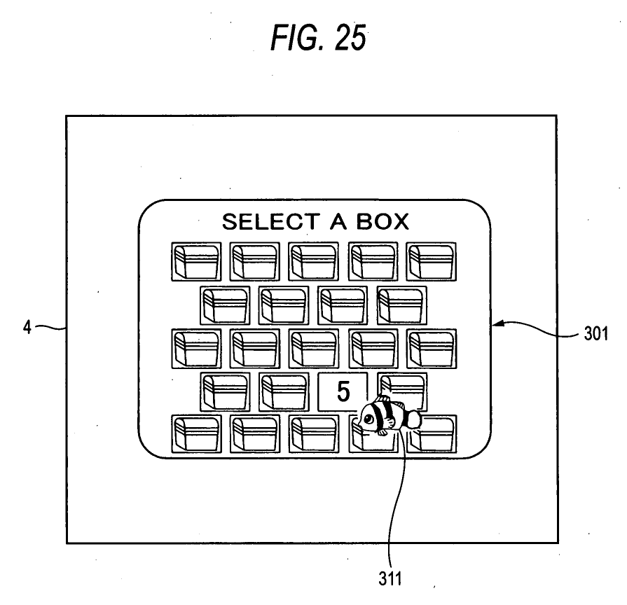

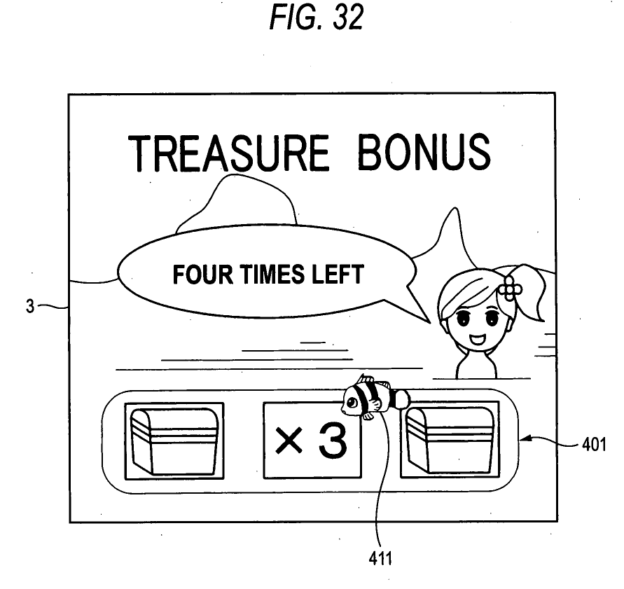

Meanwhile, when the “anemonefish” is stored in the lower treasure box 301 selected by the player, for example, as shown in FIG. 25, as well as the lower treasure box 301 which is the subject of the relevant selection being opened and the content (“5” in FIG. 25) displayed on the lower liquid crystal display 4, ananemonefish 311, which has jumped out of the lower treasure box 301 which is the subject of the relevant selection, is displayed. Furthermore, the anemonefish 311, for example, as shown in FIG. 32, moving to one of the upper treasure boxes 401 yet to be opened on the upper liquid crystal display 3 and being displayed as an anemonefish 411, and furthermore, being displayed in such a way as to open the upper treasure box 401, the content (“×3” in FIG. 32) is displayed immediately afterwards.

At this time, the upper treasure box 401 to be opened by the anemonefish 411 displayed on the upper liquid crystal display 3 is determined, in the embodiment, by a lottery based on a table (refer to FIG. 31) and a random number value sampled in a range of 0 to 127 via the random number sampling circuit 56.

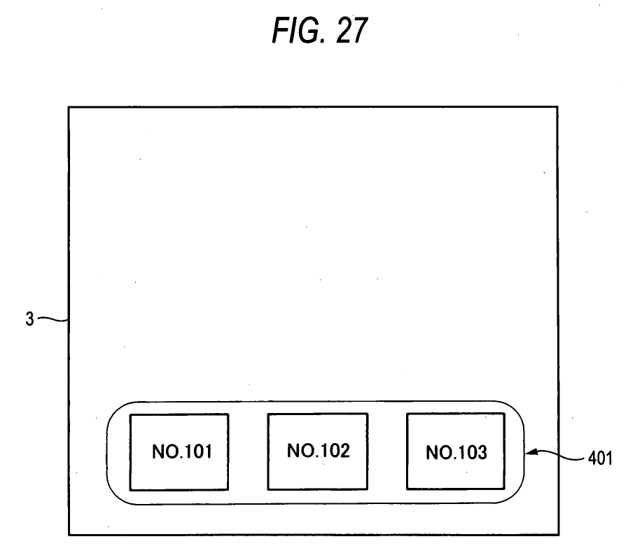

That is, for example, as shown in FIG. 27, a numbering sampling based on No. 101 to No. 103 is performed in advance for the three upper treasure boxes 401 displayed on the upper liquid crystal display 3.

Then, according to the table in FIG. 31, in the event that the random number value sampled via the random number sampling circuit 56 is any one of “0” to “43”, the first upper treasure box 401 is chosen as the upper treasure box 401 to be opened by the anemonefish 411 displayed on the upper liquid crystal display 3. Also, in the event that the random number value sampled via the random number sampling circuit 56 is any one of “44” to “103”, the second upper treasure box 401 is chosen as the upper treasure box 401 to be opened by the anemonefish 411 displayed on the upper liquid crystal display 3. Also, in the event that the random number value sampled via the random number sampling circuit 56 is any one of “104” to “127”, the third upper treasure box 401 is chosen as the upper treasure box 401 to be opened by the anemonefish 411 displayed on the upper liquid crystal display 3.

Naturally, in the event that the upper treasure box 401 chosen to be opened by the anemonefish 411 displayed on the upper liquid crystal display 3 has already been opened, the above-described lottery is repeated until a not yet opened upper treasure box 401 is chosen. Meanwhile, in the event that all the upper treasure boxes 401 have been opened, as it is not possible for the anemonefish 411 to open one of the upper treasure boxes 401, the lottery is not performed either.

Then, the player is able to obtain the content of the upper treasure box 401 opened by the anemonefish 411 displayed on the upper liquid crystal display 3. That is, when the content of the upper treasure box 401 is “number of times+once”, a number of times which the player can select the lower treasure box 301 is increased by one. When the content is “number of times+twice”, the number of times which the player can select the lower treasure box 301 is increased by two. When the content is “number of times+three times”, the number of times which the player can select the lower treasure box 301 is increased by three. Also, when the content of the upper treasure box 401 is “award×2”, an award of the lower treasure box 301 which the player has selected immediately before being opened by the anemonefish 411 is multiplied by two. When the content is “award×3”, the award of the lower treasure box 301 which the player has selected immediately before being opened by the anemonefish 411 is multiplied by three. When the content is “award×5”, the award of the lower treasure box 301 which the player has selected immediately before being opened by the anemonefish 411 is multiplied by five. When the content is “award×10”, the award of the lower treasure box 301 which the player has selected immediately before being opened by the anemonefish 411 is multiplied by ten. Also, when the content of the upper treasure box 401 is “100”, an award of “100” can be obtained. When the content is “200”, an award of “200” can be obtained. Also, when the content of the upper treasure box 401 is “all awards×2”, the awards of all the lower treasure boxes 301 which the player has selected are multiplied by two.

In this way, on completing the number of selections of the lower treasure boxes 301 determined by the content (“3 times”, “4 times” or “5 times”) of the shell 211 selected by the player in the shell chance game and the content (“number of times+once”, “number of times+twice” or “number of times+three times”) of the first or the third treasure box 401 opened by the anemonefish 411 in the treasure bonus game, the player can obtain as an award a total of the contents (one of “5”, “10”, “20”, “30”, “40”, “50”, “60”, “70”, “80”, “100” or “200”) of each of the lower treasure boxes 301 opened by the player and the content (either of “100” or “200”) of the third upper treasure box 401 opened by the anemonefish 411. Naturally, when the content of the second or the third upper treasure box 401 opened by the anemonefish 411 is any of “award×2”, “award×3”, “award×5”, “award×10” or “all awards×2”, the award is increased in accordance with the content.

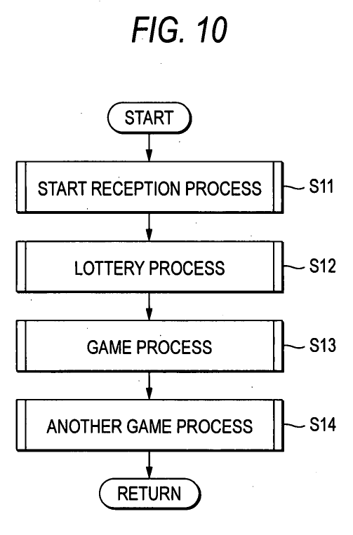

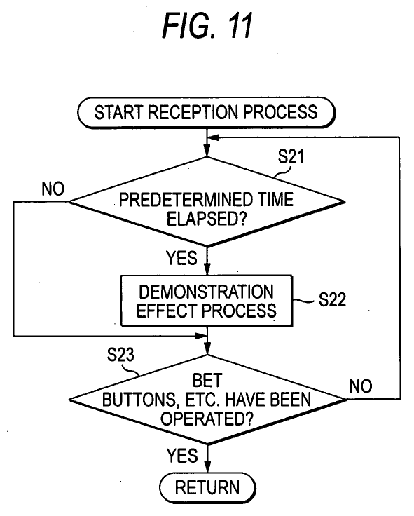

Next, the main process program executed in the slot machine 1 is described with reference to FIG. 10. FIG. 10 is a flowchart of the main process program. In FIG. 10, firstly, a start reception process of FIG. 11 (described later) is executed in step (hereafter abbreviated as “S”) 11. This process is a process in which a switch signal transmitted from the SPIN switch 57, 1-BET switch 58, 3-BET switch 59, 5-BET switch 60 or 8-BET switch 61 is received based on an operation of the SPIN/REPEATBET button 12, an operation of the 1-BET button 11, an operation of the 3-BET button 13, an operation of the 5-BET button 14 or an operation of the 8-BET button 15. The game is started at a point at which the switch signal transmitted from each switch has been received.

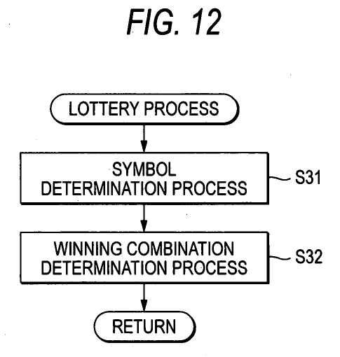

Then, in S12, a lottery process of FIG. 12 (described later) is executed based on the switch signal transmitted from the SPIN switch 57, 1-BET switch 58, 3-BET switch 59, 5-BET switch 60 or 8-BET switch 61.

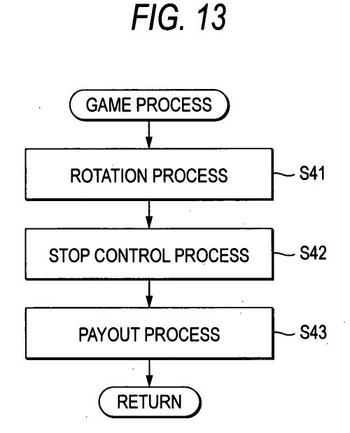

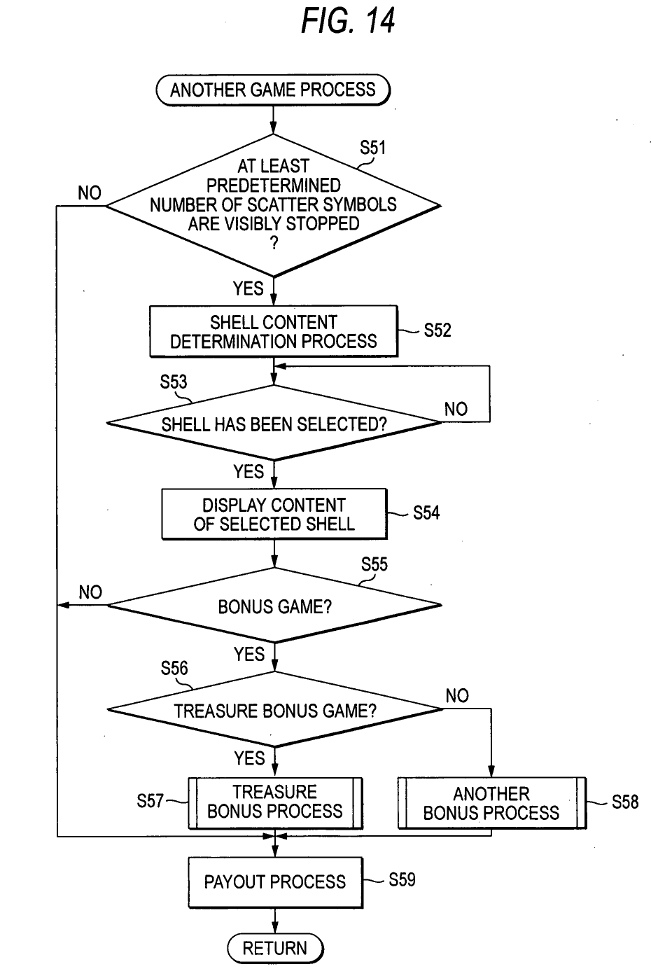

A game process of FIG. 13 (described later) being executed in a next S13, and subsequently, another game process of FIG. 14 (described later) is executed in S14. Then, the main process program is completed.

The start reception process program executed in the slot machine 1 is described with reference to FIG. 11. FIG. 11 is a flowchart of the start reception process program. In S11 of the main process program of FIG. 10, the start reception process is executed. Firstly, proceeding to S21 of FIG. 11, it is determined whether or not a predetermined time (for example, 15 seconds) has elapsed. At this point, if it is determined that the predetermined time has not elapsed (S21: No), the program proceeds to S23 without doing anything. If it is determined that the predetermined time has elapsed (S21: Yes), a demonstration effect on the upper liquid crystal display 3 and the lower liquid crystal display 4 is performed in S22, the program thereafter proceeds to S23. Then, in S23, it is determined whether or not the operation of the SPIN/REPEATBET button 12, the operation of the 1-BET button 11, the operation of the 3-BET button 13, the operation of the 5-BET button 14 or the operation of the 8-BET button 15 has been pefrormed. At this point, if it is determined that the operation of the buttons such as 1-BET button 11 has not been performed (S23: No), the program returns to S21 and repeats the above described process. If it is determined that the operation of the buttons such as 1-BET button has been performed (S23: Yes), it interrupts the demonstration effect, and a predetermined number of the activated pay lines L1 to L8 is displayed on the lower liquid crystal display 4 and the payout table 123 formed of the any odds payout table 121 and also the line odds payout table 122 shown in FIG. 9 is displayed on the upper liquid crystal display 3. Subsequently, it returns to the main process of FIG. 10 and proceeds to the lottery process of S12.

Next, the lottery process program executed in the slot machine 1 is described with reference to FIG. 12. FIG. 12 is a flowchart of the lottery process program. In S12 of the main process program of FIG. 10, the lottery process is executed. Firstly, proceeding to S31 of FIG. 12, a symbol lottery process is performed. Herein, symbols to be visibly stopped in the variable display portions 22A to 22C, 23A to 23C and 24A to 24C during the game (S42 in FIG. 13, described later) are determined for each of the variable display portions 22A to 22C, 23A to 23C and 24A to 24C. Specifically, as described above, nine random number values are sampled from the range of 0 to 127 by the random number sampling circuit 56 to correspond to the variable display portions 22A to 22C, 23A to 23C and 24A to 24C. Then, based on the lottery table in FIG. 8, visible stop symbols are determined via the code numbers. When the symbols to be visibly stopped in each of the variable display portions 22A to 22C, 23A to 23C and 24A to 24C have been determined, a winning combination determination process is thereafter performed in S32. In the winning combination determination process, to be specific, as described above, a winning combination and an award are determined for an activated one of the pay lines L1 to L8 displayed on the lower liquid crystal display 4 via the code number in S31 based on the table stored in the ROM 51 as the payout table 123 of FIG. 9.

Subsequently, returning to the main process program of FIG. 10, the program proceeds to the game process of S13.

Next, the game process program executed in the slot machine 1 is described with reference to FIG. 13. FIG. 13 is a flowchart of the game process program. In S13 of the main process program of FIG. 10, the game process is executed. Firstly, a rotation process is performed in S41 of FIG. 13. In the rotation process, to be specific, based on the switch signal transmitted from the SPIN switch 57, 1-BET switch 58, 3-BET switch 59, 5-BET switch 60 or 8-BET switch 61 which has been received in S11 of FIG. 10, an image of each symbol configuring the video reel 100 is scrolled from the right direction to the left direction in each of the variable display portions 22A to 22C, 23A to 23C and 24A to 24C.

Then, a stop control process is performed in S42. In the stop control process, to be specific, based on a lottery result of the symbol lottery process of S31, the images of the individual symbols configuring the video reel 100 are stopped in the variable display portions 22A to 22C, 23A to 23C and 24A to 24C. By this means, a visible stop of each symbol is performed.

Next, in S43, in accordance with a winning combination of symbols visibly stopped in the variable display portions 22A to 22C, 23A to 23C and 24A to 24C of the activated pay lines L1 to L8 displayed on the lower liquid crystal display 4, a coin or the like equivalent to an award preset in the payout table 123 of FIG. 9 is paid out. At this time, when winning combinations are established on a plurality of the activated pay lines L1 to L8, awards of the winning combinations are added together. Consequently, for example, when a plurality of any odds or a plurality of line odds are established simultaneously, after multiplying awards of the odds for which award change information is displayed on the upper liquid crystal display 3 by a multiple of the relevant award change information, the coin or the like equivalent to an amount of a total of each of the awards is paid out.

Subsequently, returning to the main process program of FIG. 10, the program proceeds to the another game process of S14.

Next, the another game process program executed in the slot machine 1 is described with reference to FIG. 14. FIG. 14 is a flowchart of the another game process program. In S14 of the main process program of FIG. 10, the another game process is executed. Firstly, in S51 of FIG. 14, it is determined whether or not at least a predetermined number of symbols of the scatter 100 have been visibly stopped in the variable display portions 22A to 22C, 23A to 23C and 24A to 24C of the activated pay lines L1 to L8 displayed on the lower liquid crystal display 4. The predetermined number in the embodiment is three (see FIG. 15).

Herein, if it is determined that at least the predetermined number of images of the scatter 100 have not been visibly stopped (S51: No), the program proceeds to a payout process S59 (described later). Meanwhile, if it is determined that at least the predetermined number of images of the scatter 100 have been visibly stopped (S51: Yes), the program proceeds to S52.

In S52, a shell content determination process is performed. Specifically, as described above, the five shells 211 are displayed on the lower liquid crystal display 4 (see FIG. 16). The content of the five shells 211 is determined as one of “A”, “B(3)”, “B(4)”, “B(5)”, “10”, “20” or “30” by a lottery being performed for each of the shells 211 based on the table (see FIG. 17) and the random number value sampled in the range of 0 to 127 via the random number sampling circuit 56.

Then, proceeding to S53, the program waits until the player selects one of the five shells 211 displayed on the lower liquid crystal display 4 (S53: No). As described above, the player can select any one of the five shells 211 via a touch of the transparent touch sensitive screen 201.

Then, when the player selects one of the five shells 211 displayed on the lower liquid crystal display 4 (S53: Yes), the program proceeds to S54. Then, the content of the shell 211 having been selected by the player is displayed on the lower liquid crystal display 4. In the embodiment, as shown in FIG. 18 for example, the contents of all of the shells 211 are displayed, and also an arrow in order to clarify which shell 211 the player has selected is displayed.

Then, proceeding to S55, it is determined whether or not the content of the shell 211 the player has selected is the bonus game. In the determination, it is taken that it is the bonus game in the event that the content of the shell 211 the player has selected is “A” or any of “B(3)”, “B(4)” or “B(5)”, while it is not the bonus game when the content of the shell 211 the player has selected is “10” or either of “20” or “30”. Herein, when it is determined that the content of the shell 211 the player has selected is not the bonus game (S55: No), the program proceeds to the payout process of S59 (described later). Meanwhile, when it is determined that the content of the shell 211 the player has selected is the bonus game (S55: Yes), the program proceeds to S56.

In S56, it is determined whether or not the bonus game is the treasure bonus game. In the determination, it is taken that it is not the treasure bonus game when the content of the shell 211 the player has selected is “A”, while it is the treasure bonus game in when the content of the shell 211 the player has selected is any of “B(3)”, “B(4)” or “B(5)”. Herein, when it is determined that the bonus game is not the treasure bonus game (S56: No), after another bonus process is performed in S58, the program proceeds to S59. Although the another bonus game is performed in the another bonus process in S58, a description thereof will be omitted here. Meanwhile, when it is determined that the bonus game is the treasure bonus game (S56: Yes), after a treasure bonus process of FIG. 19 (described later) is performed in S57, the program proceeds to S59.

The payout process is performed in S59. In the payout process, when it is determined that the content of the shell 211 selected by the player in S55 is “10”, “20” or “30” (S55: No), as each of the numbers represents an award, a coin or the like equivalent to the award is paid out. Also, with regard to an award obtained by the player in the another bonus game in S58 or the treasure bonus game in S57, a coin or the like equivalent to the award is also paid out by the payout process.

After the process of S59 is performed, the main process program of FIG. 10 is completed, and the main process program of FIG. 10 is started anew.

Next, a treasure bonus game process program executed in the slot machine 1 is described with reference to FIG. 19. FIG. 19 is a flowchart of the treasure bonus game process program. In S57 of the another game process program of FIG. 14, the treasure bonus game process is executed. Firstly, in S71 of FIG. 19, a content determination process is performed for each treasure box. Specifically, as shown in FIG. 20 for example, the 23 lower treasure boxes 301 are displayed on the lower liquid crystal display 4. The lower treasure boxes 301 serve as an example of selectable elements. Then, as described above, a lottery is performed for each of the lower treasure boxes 301 based on the table (see FIG. 22) and the random number value sampled in the range of 0 to 127 via the random number sampling circuit 56. By this means, the content of each of the lower treasure boxes 301 is determined as one of “5”, “10”, “20”, “30”, “40”, “50”, “60”, “70”, “80”, “100” or “200”. The content of the lower treasure boxes 301 serve as an example of extra information relating to a game associated with the selectable elements. In this embodiment, all the lower treasure boxes 301 is associated with the award, however, it is not limited to this. Not all the lower treasure boxes 301 may be associated with the award. Further, the content of the lower treasure boxes 301 as the extra information is not limited to the award, for example, extra information may include information for adding the number of selecting times, information multiplying the obtained award, etc. Furthermore, a lottery is performed for each of the lower treasure boxes 301 based on the table (see FIG. 23) and the random number value sampled in the range of 0 to 127 via the random number sampling circuit 56. By this means, it is determined whether or not to add an existence of the “anemonefish” to the contents of each of the lower treasure boxes 301. The lower treasure box 301 associated with “anemonefish” as a content thereof serves as an example of a first selectable element. The content of each of the lower treasure boxes 301 is stored in a table provided in the RAM 52.

Furthermore, as shown in FIG. 26 for example, the three upper treasure boxes 401 are displayed on the lower liquid crystal display 3. As described above, a lottery is performed for each of the upper treasure boxes 401 based on the table (see FIGS. 28 to 30) and the random number value sampled in the range of 0 to 127 via the random number sampling circuit 56. By this means, the content of the first upper treasure box 401 is determined as one of “number of times+once”, “number of times+twice” or “number of times+three times”, the content of the second upper treasure box 401 is determined as one of “award×2”, “award×3”, “award×5” or “award×10”, “number of times+three times”,and the content of the third upper treasure box 401 is determined as one of “100”, “200”, “number of times+three times”, “award×5”, “award×10” or “all awards×2”. The content of each of the upper treasure boxes 401 is stored in a table provided in the RAM 52.

Also, as shown in FIG. 26, the number of times the player can select one of the lower treasure boxes 301 is displayed on the upper liquid crystal display 3 as the remaining number of times. Specifically, it is displayed as “3 times remaining”when the content of the shell 211 the player has selected in the shell chance game is “B(3)”, displayed as “4 times remaining” when the content is “B(4)”, and displayed as “5 times remaining” when the content is “B(5)”. The remaining number of times the player can select one of the lower treasure boxes 301 is stored in the RAM 52.

Then, proceeding to S72, the program waits until one of the lower treasure boxes 301 is selected by the player (S72: No). As described above, the player can select one lower treasure box 301 of the lower treasure boxes 301 displayed on the lower liquid crystal display 4 via a touch of the transparent touch sensitive screen 201. A plurality of lower treasure boxes 301 may be selected at one selecting time. However, the player is not permitted to select the lower treasure box 301 already opened on the lower liquid crystal display 4. For checking whether the lower treasure box 301 has already been opened, for example, a flag (provided in the RAM 52) corresponding to each lower treasure box 301 is used. Then, when one of the lower treasure boxes 301 is selected by the player (S72: Yes), the remaining number of times which the player can select one of the lower treasure boxes 301 is reduced by “1” and stored in the RAM 52. The display of the remaining number of times is updated on the upper liquid crystal display 3. Then, the program proceeds to S73.

In S73, the lower treasure box 301 selected by the player is opened and the content (one of “5”, “10”, “20”, “30”, “40”, “50”, “60”, “70”, “80”, “100” or “200”) is displayed on the lower liquid crystal display 4 (for example, see FIG. 24 and FIG. 25). The display process is performed based on, for example, the table (provided in the RAM 52) stored in connection with the content of each lower treasure box 301. The fact that the box has been opened is stored in the flag (provided in the RAM 52) corresponding to each of the lower treasure boxes 301.

Then, proceeding to S74, it is determined whether or not the “anemonefish” exists in the lower treasure box 301 selected by the player. The determination is performed based on, for example, the table (provided in the RAM 52) stored in connection with the existence or otherwise of the “anemonefish” in each lower treasure box 301. When it is determined that the “anemonefish” does not exist in the lower treasure box 301 selected by the player (S74: No), the program proceeds to S75 (described later). When it is determined that the “anemonefish” exists in the lower treasure box 301 selected by the player (S74: Yes), the program proceeds to S76.

In S76, it is determined whether or not there is a remaining upper treasure box 401 on the upper liquid crystal display 3. The determination is performed by means of, for example, checking whether or not there is a still unopened upper treasure box 401 on the upper liquid crystal display 3 with a flag (provided in-the RAM 52) corresponding to each upper treasure box 401. When it is determined that there is no remaining upper treasure box 401 on the upper liquid crystal display 3 (S76: No), the program proceeds to an object process of S79, to be described hereafter. Meanwhile, when it is determined that there is a remaining upper treasure box 401 on the upper liquid crystal display 3 (S76: Yes), the program proceeds to S77.

In S77, a process to determine the upper treasure box 401 to be opened by the anemonefish 411 displayed on the upper liquid crystal display 3 is performed. Specifically, for example, as described above, a lottery based on the table (see FIG. 31) and the random number value sampled in the range of 0 to 127 via the random number sampling circuit 56 is performed. By this means, the upper treasure box 401 to be opened by the anemonefish 411 displayed on the upper liquid crystal display 3 is determined, the program thereafter proceeds to S78.

Then, proceeding to S78, the anemonefish 311 is displayed to jump out of the lower treasure box 301 opened in S73 on the lower liquid crystal display 4. The anemonefish 311 serves as an example of an object displayed when the first selectable element is selected by the player. Then, the anemonefish 311 jumped out of the lower treasure box is displayed to move on the upper liquid crystal display 3 as the anemonefish 411. As far as the upper treasure box 401 determined in S77, the program opens the upper treasure box 401 determined in S77 and displays the content thereof (one of “number of times+once”, “number of times+twice”, “number of times+three times”, “award×2”, “award×3”, “award×5”, “award×10”, “100”, “200” or “all awards×2”) (for example, see FIG. 32). Then, it proceeds to the object process of S79 (described later). The display of the content is performed based on, for example, the table (provided in the RAM 52) stored in connection with the content of each upper treasure box 401. Also, the fact that the box has been opened is stored in the flag (provided in the RAM 52) corresponding to the upper treasure box 401.

When the content of the upper treasure box 401 opened at this time is any of “number of times+once”, “number of times +twice” or “number of times+three times”, the remaining number of times which the player can select one of the lower treasure boxes 301 is stored in the RAM 52 with “1”, “2” or “3” added thereto, and the remaining number of times displayed on the upper liquid crystal display 3 is updated.

After the object process to be described later is performed in S79, returning to S72, the above described process is repeated.

Meanwhile, in S74, when it is determined that the “anemonefish” does not exist in the lower treasure box 301 selected by the player (S74: No), as described above, the program proceeds to S75. In S75, it is determined whether or not there is a remaining time for the lower treasure box 301 to be selected by the player. In the embodiment, the remaining number of times the player can select one of the lower treasure boxes 301 is, as long as none of the upper treasure boxes 401 is opened, one of three to five times. When the first or the third upper treasure box 401 has been opened, it can be increased by once, or up to twice, three times, four times, five times or six times, depending on a combination of contents of the opened upper treasure boxes 401. As described above, the remaining number is stored in the RAM 52. When it is determined that there is a remaining time for the lower treasure box 301 to be selected by the player (S75: Yes), returning to S72, the above described process is repeated. Meanwhile, when it is determined that there is no remaining time for the lower treasure box 301 to be selected by the player (S75: No), returning to the another game process program of FIG. 14, the program proceeds to the payout process of S59.

In the payout process of S59, each award corresponding to the contents of each selected lower treasure box 301 or upper treasure box 401 is accumulated and provided. Naturally, it is also acceptable to provide the corresponding award every time the contents of each lower treasure box 301 or each upper treasure box 401 are displayed.

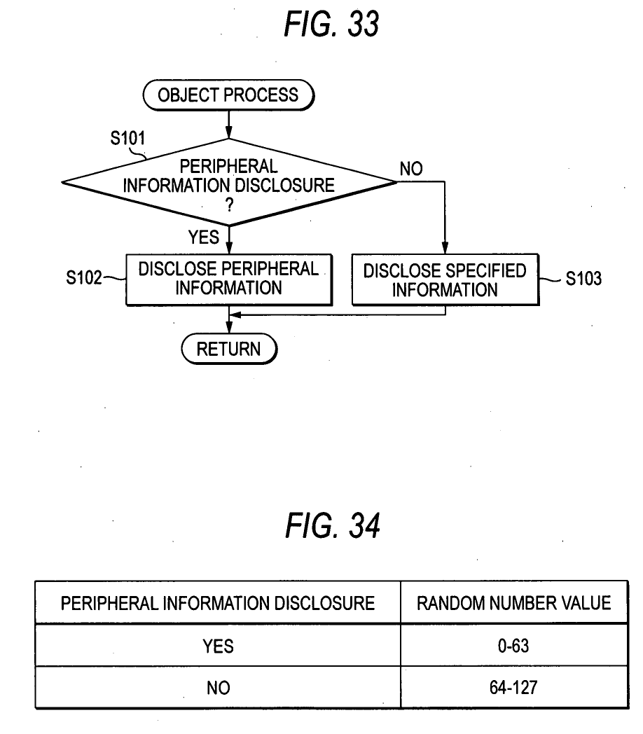

Next, an object process program executed in the slot machine 1 is described with reference to FIG. 33. FIG. 33 is a flowchart of the object process program. In S79 of the treasure bonus process program of FIG. 19, the object process is executed. Firstly, in S101 of FIG. 33, it is determined whether or not peripheral information is disclosed. The determination is performed by a lottery based on the table of FIG. 34 and a random number value sampled in the range of 0 to 127 via the random number sampling circuit 56. That is, according to the table of FIG. 34, when the random number value sampled via the random number sampling circuit 56 is any of “0” to “63”, it is determined that the peripheral information is disclosed (S101: Yes) and, after performing a peripheral information disclosure of S102 (described later), the program returns to S72 of FIG. 19. Meanwhile, when the random number value sampled via the random number sampling circuit 56 is any of “64” to “127”, it is determined that the peripheral information is not disclosed (S101: No), and a specified information disclosure of S103 (described later) is performed. The program thereafter returns to S72 of FIG. 19.

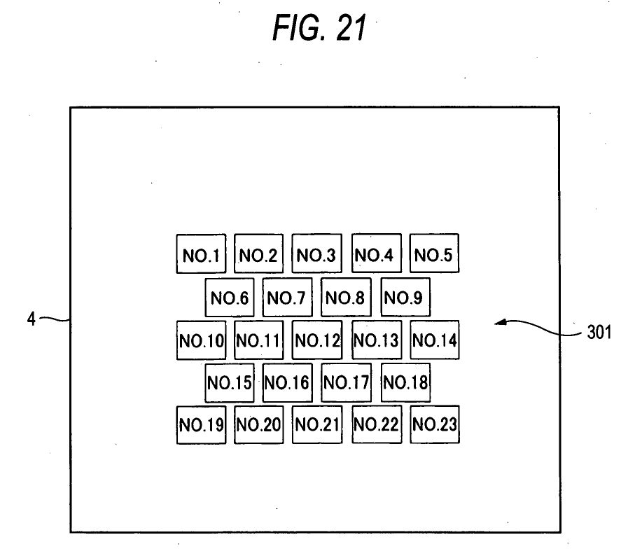

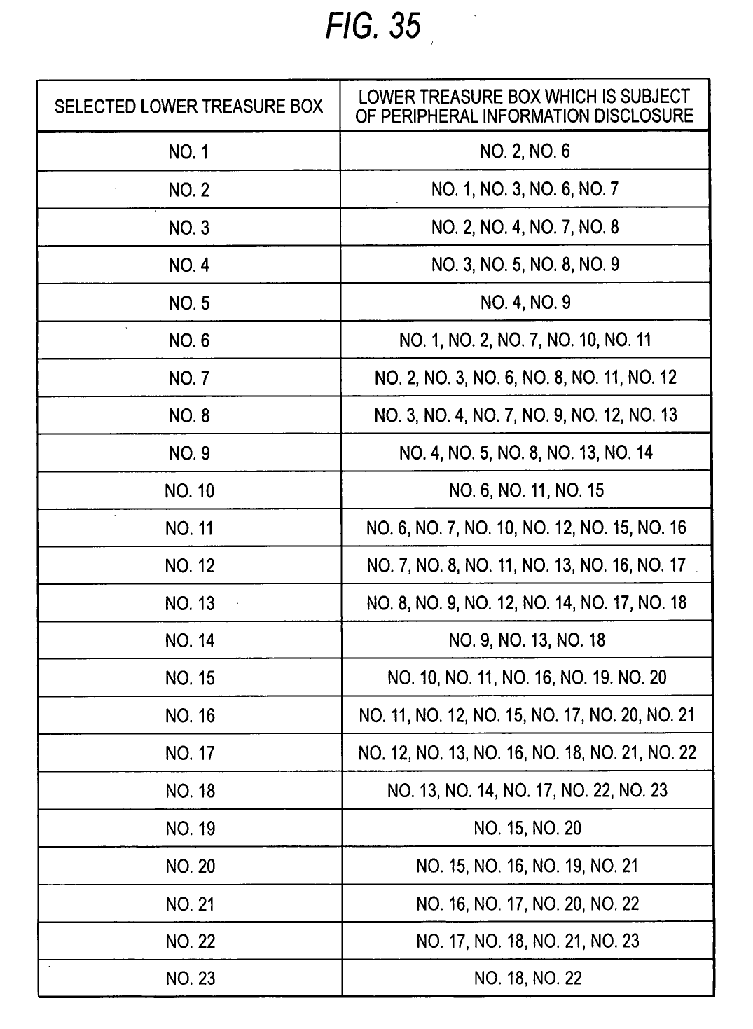

The peripheral information disclosure of S102 is a process which displays, on the lower liquid crystal display 4, the content of each still unopened lower treasure box 301 positioned in a periphery of the lower treasure box 301 from which the anemonefish 311 has been displayed to be jumped out. At S102, the content is displayed to be superimposed on the lower treasure box, for example. The displayed information at S102 serves as an example of reference information based on the extra information such as the content. In this process, the lower treasure box 301 to be a subject of the peripheral information disclosure is determined in the following way. Firstly, a numbering is performed in advance for each treasure box 301 displayed on the lower liquid crystal display 4, as shown in FIG. 21, for example. That is, identification information (e.g., number) is assigned to each treasure box 301, and the identification information is stored in the RAM 52. Also, as shown in the table of FIG. 35, in connection with each numbered treasure box 301, a number of each lower treasure box 301 to be the subject of the peripheral information disclosure when the anemonefish 311 is displayed to jump out is stored in advance. The table of FIG. 35 serves as an example of designation table that includes the identification information of at least one lower treasure box 301 to be designated with respect to the identification information of each of the lower treasure box 301 to be selected.

According to the table of FIG. 35, when the number of the treasure box 301 from which the anemonefish 311 is displayed to jumps out is number 1, the treasure boxes 301 of which the numbers are number 2 and number 6 are determined as the subjects of the peripheral information disclosure. Also, when the number of the treasure box 301 from which the anemonefish 311 is displayed to jump out is any of number 2 to number 23, the number of each treasure box 301 to be the subject of the peripheral information disclosure is determined in the same way. The table of FIG. 35 is provided in advance in the ROM 51.

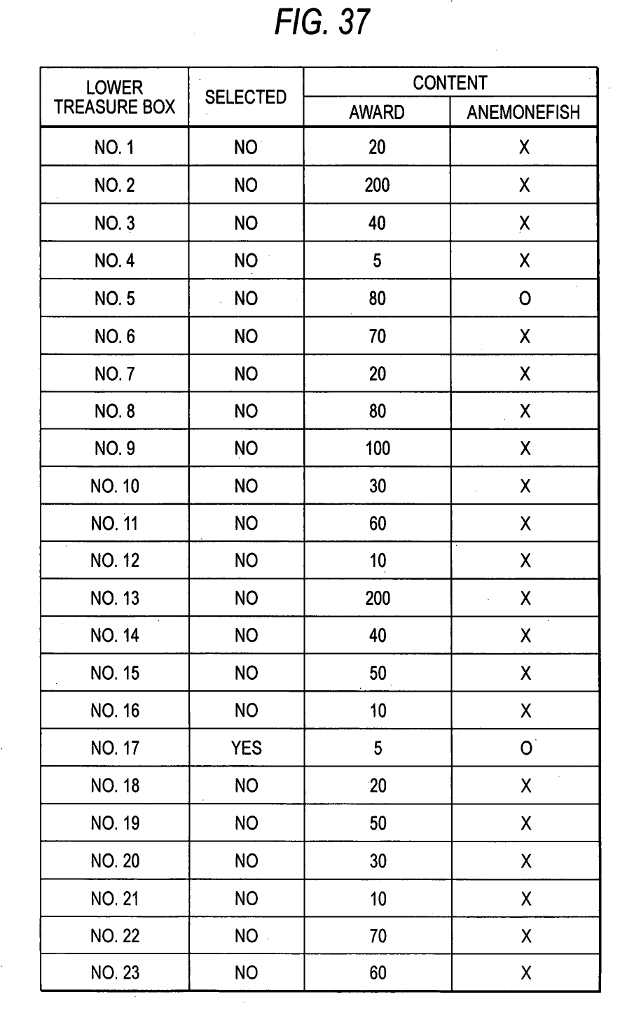

Also, as described above, it is possible to check whether each lower treasure box 301 is still unopened by means of the flag (provided in the RAM 52) corresponding to each lower treasure box 301. Also, as described above, it is possible to check the content (award) of each lower treasure box 301, and the existence or otherwise of the “anemonefish”, from the tables provided in the RAM 52. FIG. 37 is an illustration showing, as a table, a correlation relationship between the flag and the tables. In the table of FIG. 37, a number assigned to the lower treasure box is shown on each line of a “lower treasure box” section, content of a flag (“No” represents still unopened, “Yes” represents already opened) is shown on each line of a “Selection” section, and a “award” and the existence or otherwise of the “anemonefish” (“o” means it exists, “x” means it does not exist” are shown on each line of a “Content” section.

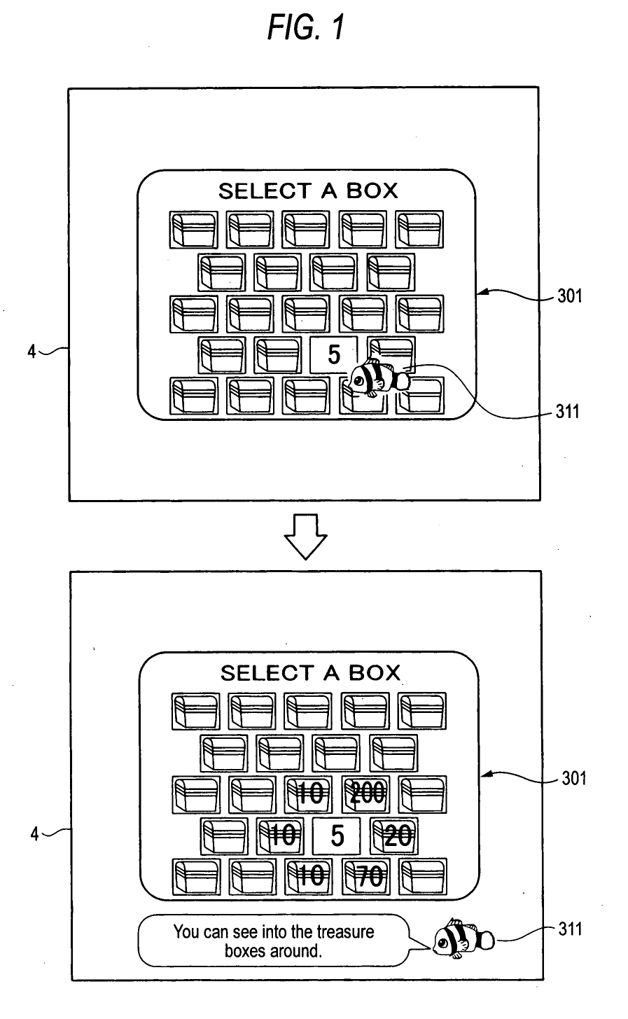

Then, to explain specifically the process of the peripheral information disclosure of S102, when the number of the treasure box 301 from which the anemonefish 311 is displayed to jump out is number 17 (see FIG. 21), as shown in FIG. 1 for example, the content of each lower treasure box 301 positioned in the periphery is displayed together with characters “You can see into the treasure boxes around!” in a speech balloon of the anemonefish 311. At this time, the subjects of the peripheral information-disclosure and their contents are a lower treasure box 301 of No. 12 and its content “10”, a lower treasure box 301 of No. 13 and its content “200”, a lower treasure box 301 of No. 16 and its content “10”, a lower treasure box 301 of No. 18 and its content “20”, a lower treasure box 301 of No. 21 and its content “10”, and a lower treasure box 301 of No. 22 and its content “70” (see FIG. 21, FIG. 35 and FIG. 37). In FIG. 1, each lower treasure box 301 which has become the subject of the peripheral information disclosure (those with the No. 12, No. 13, No. 16, No. 18, NO. 21 and No. 22) is only one which is still unopened, none of them has already been opened.

Incidentally, in the above peripheral information disclosure process, the lower treasure box 301 displayed around the lower treasure box 301 selected by the player is designated as a lower treasure box for displaying its content. However, the treasure box 301 displayed at positions that has a predetermined positional relationship with the position of the treasure box 301 selected by the player may be designated.

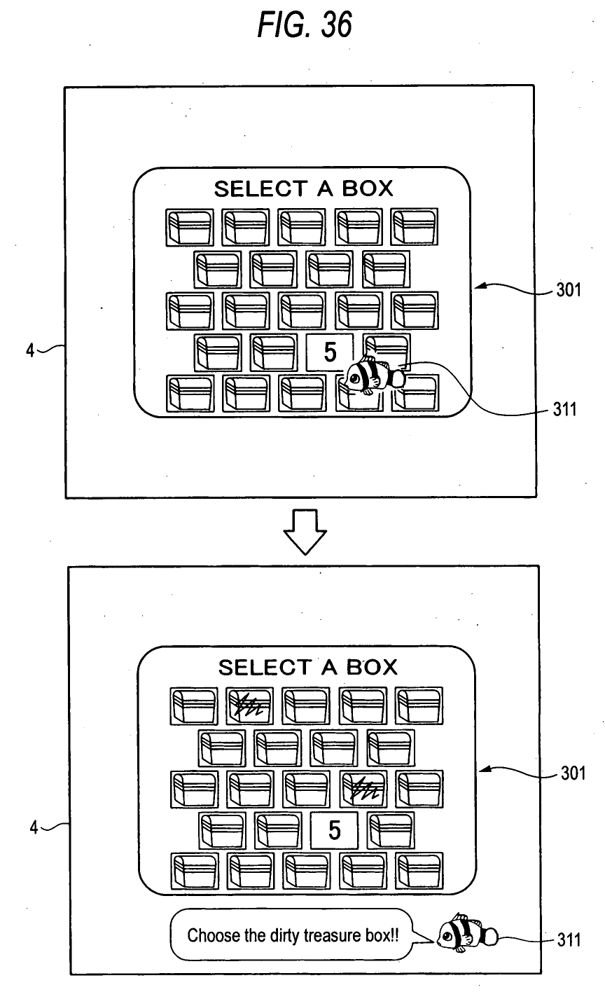

Meanwhile, the specified information disclosure of S103 is a process which displays the still unopened lower treasure boxes 301 which has a maximum award as its content with dirty mark on the lower liquid crystal display 4, together with characters “Choose the dirty treasure box!!” as a speech balloon of the anemonefish 311, as shown in FIG. 36. At least either of the dirty mark and the characters serves as the reference-information displayed on the lower display device 4. Although, in the process, a lower treasure box 301 to be a subject of the specified information disclosure is determined by the content (award) of each lower treasure box 301 and information regarding whether it is still unopened, it is possible to acquire the items of information in the same way as in the peripheral information disclosure process of S102 described above. Incidentally, in the above specified information disclosure process, the lower treasure box 301 having a maximum award as its content is designated as a lower treasure box for showing the reference information. However, the lower treasure box 301 for showing the reference information may be any kind of conditions based on the content of the lower treasure box 301.

As described in detail above, according to the slot machine 1 of the embodiment, in the treasure bonus game, when the player selects the lower treasure box 301 on the lower liquid crystal display 4 and the “anemonefish” exists in the selected lower treasure box 301 (S74: Yes, see FIG. 25), the lower treasure boxes 301 positioned in the periphery of the lower treasure box 301 selected by the player on the lower liquid crystal display 4 are designated via the number assigned to each lower treasure box 301 (see to FIG. 21 and FIG. 35). Then, the content (any of “5”, “10”, “20”, “30”, “40”, “50”, “60”, “70”, “80”, “100” or “200”) of those still unopened among the lower treasure boxes 301 which are subjects of the designation are displayed on-the lower treasure-boxes 301 (S102, refer to FIG. 1). Thus, the player is given a guide for when next selecting the lower treasure box 301, thereby maintaining the player's motivation to play. Therefore, it is possible to give a novel sensation to the player of a game in which an award corresponding to a selectable element selected by the player is provided.

The invention can be applied to a technique for automatically displaying information on a selectable element in the game in which the award corresponding to the selectable element selected is provided.

What is claimed is:

1. A gaming machine comprising:
a display device that displays a plurality of selectable elements including at least one first selectable element, at least one of the selectable elements being associated with an extra information that relates to a game;
an input device that accepts an input selecting at least one of the selectable elements; and
a processor that controls the display device based on the input from the input device,
wherein the processor is operable to:
determine whether a selectable element selected through the input device is the first selectable element;
designate at least one selectable element other than the selected selectable element if the selected selectable element is the first selectable element; and
display reference information based on the extra information corresponding to the designated selectable element on the display device.

2. The gaming machine according to claim 1, wherein the extra information includes an award.

3. The gaming machine according to claim 1, wherein the designated selectable element is determined based on a position where the selected first selectable element is displayed.

4. The gaming machine according to claim 3, wherein the selectable element displayed at positions that has a predetermined positional relationship with the position of the selected first selectable element is determined as the designated selectable element.

5. The gaming machine according to claim 4, wherein the selectable element displayed around the selected first selectable element is determined as the designated selectable element.

6. The gaming machine according to claim 1, wherein the designated selectable element is determined based on the extra information of the selectable elements.

7. The gaming machine according to claim 1, wherein the reference information displayed on the display device includes the extra information.

8. The gaming machine according to claim 1, wherein the reference information includes recommendation information to recommend the designated selectable element for a next input selecting the selectable element.

9. The gaming machine according to claim 1, wherein when displaying the reference information on the display, the processor is operable to display the reference information with an object.

10. The gaming machine according to claim 9, wherein the processor is operable to display the object on the display device if the selected selectable element is the first selectable element.

11. The gaming machine according to claim 1, further comprising a memory that stores identification information assigned to each of the selectable elements.

12. The gaming machine according to claim 11, wherein:
the memory further stores a designation table that includes the identification information of at least one of the selectable elements to be designated with respect to the identification information of each of the selectable elements to be selected,
the processor is operable to determine the selectable element with reference to the designation table.

13. The gaming machine according to claim 1, wherein the reference information is displayed to be superimposed on the respective selectable element.

14. A gaming machine comprising:
a display device that displays a plurality of selectable elements including at least one first selectable element, at least one of the selectable elements being associated with an extra information that relates to a game;
an input device that accepts an input selecting at least one of the selectable elements; and
a processor that controls the display device based on the input from the input device,
wherein the processor is operable to:
determine whether a selectable element selected through the input device is the first selectable element;
designate at least one selectable element other than the selected selectable element if the selected selectable element is the first selectable element; and
display reference information based on the extra information corresponding to the designated selectable element on the display device,
wherein the designated selectable element is determined based on a position where the selected first selectable element is displayed.

15. A gaming machine comprising:
a display device that displays a plurality of selectable elements including at least one first selectable element, at least one of the selectable elements being associated with an extra information that relates to a game;
an input device that accepts an input selecting at least one of the selectable elements; and
a processor that controls the display device based on the input from the input device,
wherein the processor is operable to:
determine whether a selectable element selected through the input device is the first selectable element;
designate at least one selectable element other than the selected selectable element if the selected selectable element is the first selectable element; and
display reference information based on the extra information corresponding to the designated selectable element on the display device,
wherein the reference information includes recommendation information to recommend the designated selectable element for a next input selecting the selectable element.
